(19) United States
(12) Patent Application Publication
(10) Pub. No.: US 2026/0241682 A1
(43) Pub. Date: Aug. 20, 2026

(54) Liquid Ejecting Apparatus

(71) Applicant: SEIKO EPSON CORPORATION, Tokyo (JP)

(72) Inventors: Kenichi OE, Matsumoto (JP); Yoichiro KONDO, Chino (JP)

(21) Appl. No.: 19/541,687

(22) Filed: Feb. 17, 2026

(30) Foreign Application Priority Data
Feb. 18, 2025 (JP) 2025-024499

(51) Int. Cl. B41J 2/045; B41J 2/14

(52) U.S. Cl. CPC B41J 2/04581; B41J 2/14072

(57) ABSTRACT

A liquid ejecting apparatus includes a head unit configured to eject a liquid to a medium in response to a plurality of signals, the head unit including a multilayer substrate in which a plurality of wiring layers are stacked, in which the multilayer substrate includes a first wiring layer and a second wiring layer and a first insulating layer, and a first through wiring and a second through wiring, which penetrate the first insulating layer, the first insulating layer contains a plurality of glass fibers including a first glass fiber, the first through wiring penetrates the first glass fiber and propagates a first signal among the plurality of signals, and the second through wiring does not penetrate the first glass fiber and propagates a second signal different from the first signal in voltage value among the plurality of signals.

The present application is based on, and claims priority from JP Application Serial Number 2025-024499, filed February 18, 2025, the disclosure of which is hereby incorporated by reference herein in its entirety.

### BACKGROUND

### 1. Technical Field

The present disclosure relates to a liquid ejecting apparatus.

### 2. Related Art

As a liquid ejecting apparatus configured to eject a liquid to form a document or an image on a medium, a device using a piezoelectric element is known. Piezoelectric elements are provided corresponding to each of a plurality of ejecting portions in a print head. When the piezoelectric element is driven according to a drive signal, an amount of liquid is ejected from the corresponding ejecting portion according to the drive of the piezoelectric element, and dots are formed at the medium.

JP-A-2022-150857 discloses a liquid ejecting apparatus configured to eject a liquid in response to driving of a piezoelectric element to form a dot at a medium.

However, from the viewpoint of reducing influence of migration occurring in a wiring board used in the liquid ejecting apparatus, the technique disclosed in JP-A-2022-150857 is not sufficient, and there is room for improvement.

### SUMMARY

According to an aspect of the present disclosure, a liquid ejecting apparatus includes:

a transport portion configured to transport a medium; and

a head unit configured to eject a liquid onto the medium in response to a plurality of ejection control signals,

in which the head unit includes a multilayer substrate in which a plurality of wiring layers that propagate the plurality of ejection control signals are stacked,

the multilayer substrate includes

a first wiring layer and a second wiring layer among the plurality of wiring layers,

a first insulating layer that is positioned between the first wiring layer and the second wiring layer along a stacking direction in which the plurality of wiring layers are stacked, and

a first through wiring and a second through wiring, which penetrate the first insulating layer,

the first insulating layer contains a plurality of glass fibers including a first glass fiber,

the first through wiring penetrates the first glass fiber and propagates a first ejection control signal among the plurality of ejection control signals, and

the second through wiring does not penetrate the first glass fiber and propagates a second ejection control signal different from the first ejection control signal in voltage value among the plurality of ejection control signals.

### BRIEF DESCRIPTION OF THE DRAWINGS

FIG. 1 is a view illustrating a schematic configuration of a liquid ejecting apparatus.

FIG. 2 is a view illustrating a functional configuration of the liquid ejecting apparatus.

FIG. 3 is a diagram illustrating an example of signal waveforms of drive signals.

FIG. 4 is a diagram illustrating an example of a waveform of a drive signal.

FIG. 5 is a view illustrating a configuration of a drive signal selection circuit.

FIG. 6 is a diagram illustrating an example of decoding contents in a decoder.

FIG. 7 is a view illustrating a configuration of a selection circuit corresponding to one ejecting portion.

FIG. 8 is a view for explaining an operation of the drive signal selection circuit.

FIG. 9 is a view illustrating an example of a configuration of a temperature abnormality detection circuit.

FIG. 10 is a view illustrating an example of a structure of the ejecting portion.

FIG. 11 is a view for explaining a structure of a print head.

FIG. 12 is a view illustrating an example of a structure of a print head as viewed from a +Z side toward a -Z side along a Z axis.

FIG. 13 is a view for explaining an example of an internal structure of the print head.

FIG. 14 is a view for explaining a schematic layer structure of a wiring board.

FIG. 15 is a view illustrating an example of a configuration of a wiring layer as viewed from a surface along a stacking direction of the wiring board.

FIG. 16 is a view illustrating an example of a configuration of a wiring layer as viewed from the surface along the stacking direction of the wiring board.

FIG. 17 is a view illustrating an example of a configuration of a wiring layer as viewed from the surface along the stacking direction of the wiring board.

FIG. 18 is a view illustrating an example of a configuration of a wiring layer as viewed from the surface along the stacking direction of the wiring board.

FIG. 19 is a view illustrating an example of a configuration of a wiring layer as viewed from the surface along the stacking direction of the wiring board.

FIG. 20 is a view illustrating an example of a configuration of a wiring layer as viewed from the surface along the stacking direction of the wiring board.

FIG. 21 is a view for explaining a configuration of a glass cloth contained in an insulating layer of the wiring board.

FIG. 22 is a view illustrating an example of a disposition of vias that reduce a concern that short-circuit abnormality occurs due to growth of migration in the wiring board.

FIG. 23 is a view for explaining a disposition of vias that can reduce a concern that short-circuit abnormality occurs due to growth of migration in a wiring board included in a liquid ejecting apparatus 1 according to a second embodiment.

### DESCRIPTION OF EMBODIMENTS

Hereinafter, preferred embodiments of the present disclosure will be described with reference to the drawings. The drawings to be used are for convenience of description. Embodiments to be described below do not inappropriately limit the contents of the present disclosure described in the claims. In addition, the configurations described below are not necessarily all essential constituent elements of the present disclosure.

### First embodiment

### 1. Structure of liquid ejecting apparatus

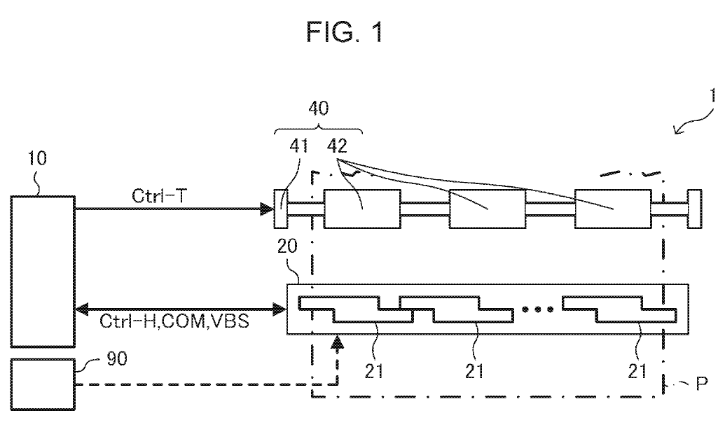

FIG. 1 is a view illustrating a schematic configuration of a liquid ejecting apparatus 1. The liquid ejecting apparatus 1 is a line printing-type ink jet printer that forms a desired image at a medium P by ejecting an ink that is an example of a liquid, onto the medium P using a head unit 20 configured to eject the ink, the medium P being transported along a transport direction. The liquid ejecting apparatus 1 is not limited to the line printing-type ink jet printer, and may be a serial printing-type ink jet printer. As the medium P that is used in such a liquid ejecting apparatus 1, any printing target such as a printing paper, a resin film, and a cloth can be used.

As illustrated in FIG. 1, the liquid ejecting apparatus 1 includes a control unit 10, a head unit 20, a transport unit 40, and an ink container 90.

A plurality of types of ink to be ejected onto the medium P are stored in the ink container 90. Examples of colors of the ink stored in the ink container 90 include black, cyan, magenta, yellow, red, and gray. An ink cartridge, a bag-shaped ink pack made of a flexible film, an ink-refillable ink tank, and the like may be used as the ink container 90 storing such ink.

The control unit 10 includes, for example, a processing circuit such as a central processing unit (CPU) and a field programmable gate array (FPGA), and a storage circuit such as a semiconductor memory; and controls each element of the liquid ejecting apparatus 1 including the head unit 20 and the transport unit 40.

The head unit 20 includes a plurality of print heads 21. The plurality of print heads 21 are arranged side by side along a scanning direction orthogonal to the transport direction of the medium P to have a width equal to or larger than a width of the medium P. A control signal Ctrl-H for controlling the print head 21, and a drive signal COM and a reference voltage signal VBS for driving the head unit 20 are input to each of the plurality of print heads 21 from the control unit 10. In addition, the ink stored in the ink container 90 is supplied to each of the plurality of print heads 21 through a tube (not illustrated). Each of the plurality of print heads 21 ejects the ink supplied from the ink container 90 based on the input control signal Ctrl-H, drive signal COM, and reference voltage signal VBS.

The transport unit 40 includes a transport motor 41 and transport rollers 42. The transport motor 41 is driven based on a control signal Ctrl-T that is input from the control unit 10. The transport rollers 42 rotate in accordance with the driving of the transport motor 41. The medium P is transported in the transport direction in accordance with the rotation of the transport rollers 42.

In the liquid ejecting apparatus 1 configured as described above, the plurality of print heads 21 included in the head unit 20 eject the ink onto the medium P in conjunction with the transport of the medium P by the transport unit 40. As a result, the ink ejected from each of the plurality of print heads 21 lands on any position on a surface of the medium P, and thus the desired image is formed at the medium P.

That is, the liquid ejecting apparatus 1 includes the transport unit 40 that transports the medium P, and the head unit 20 including the print head 21 that ejects the ink that is an example of the liquid, onto the medium P in response to the control signal Ctrl-H, the drive signal COM, and the reference voltage signal VBS.

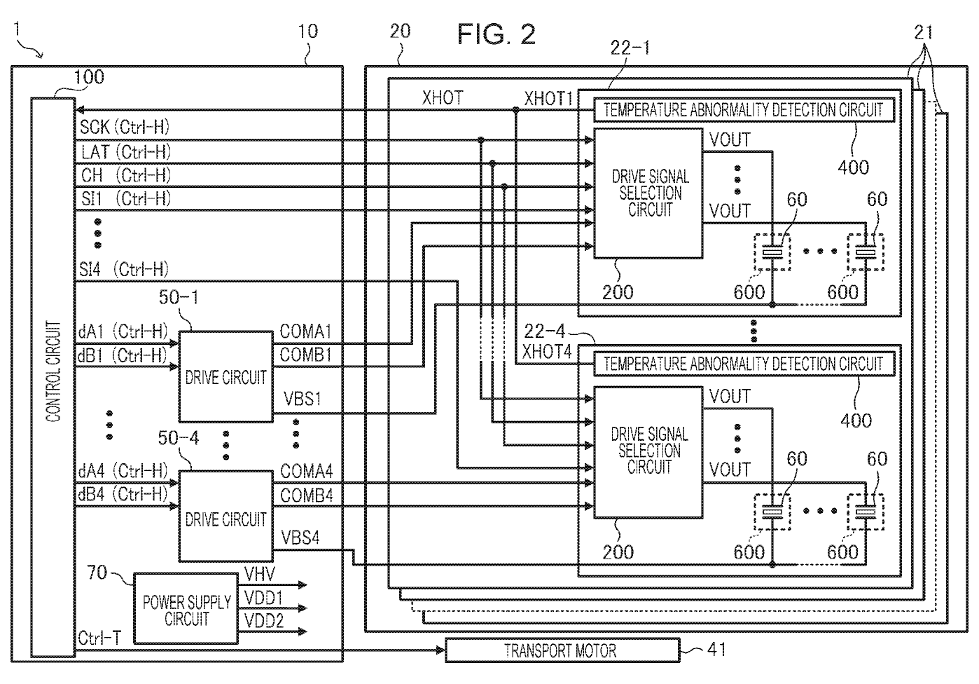

Next, a specific example of a functional configuration of the liquid ejecting apparatus 1 will be described. FIG. 2 is a view illustrating the functional configuration of the liquid ejecting apparatus 1. As illustrated in FIG. 2, the liquid ejecting apparatus 1 includes the control unit 10, the head unit 20, and a transport motor 41. The control unit 10 and the head unit 20 are electrically connected to each other by, for example, a flexible flat cable (FFC). Here, all of the plurality of print heads 21 included in the head unit 20 have the same configuration. Therefore, in the following description, one print head 21 among the plurality of print heads 21 included in the head unit 20 will be focused on and described.

The control unit 10 includes drive circuits 50-1 to 50-4, a power supply circuit 70, and a control circuit 100.

The power supply circuit 70 converts a power supply voltage input from the outside into constant voltage signals VHV, VDD1, and VDD2 having predetermined voltage values, and outputs the voltage signals. Here, the voltage signals VHV, VDD1, and VDD2 are power supply voltages used in each configuration of the liquid ejecting apparatus 1; and in the liquid ejecting apparatus 1 according to the present embodiment, the voltage signal VHV is a direct current voltage signal of 42 V, the voltage signal VDD1 is a direct current voltage signal of 5 V, and the voltage signal VDD2 is a direct current voltage signal of 5 V. The power supply circuit 70 can be configured to include an AC/DC converter, a DC/DC converter, or the like. The voltage values of the voltage signals VHV, VDD1, and VDD2 are not limited to the above-described values. In addition, the power supply circuit 70 may output a plurality of power supply voltages, in addition to the voltage signals VHV, VDD1, and VDD2. The power supply circuit 70 supplies the generated voltage signals VHV, VDD1, and VDD2 to each unit of the liquid ejecting apparatus 1 including the control unit 10 and the head unit 20, which are various configurations of the liquid ejecting apparatus 1.

The control circuit 100 includes, for example, a processing circuit such as a CPU and an FPGA, and a storage circuit such as a semiconductor memory, and operates, for example, using the voltage signal VDD1 as a power supply voltage. The control circuit 100 receives an image information signal including image data or the like from an external device such as a host computer that is coupled to the outside of the liquid ejecting apparatus 1 in a communicable manner. The control circuit 100 generates various signals for controlling the liquid ejecting apparatus 1 based on the input image information signal, and outputs the generated various signals to corresponding configurations.

In the specific example, the control circuit 100 generates the control signal Ctrl-T for controlling the transport of the medium P, and outputs the control signal Ctrl-T to the transport motor 41. Accordingly, the transport motor 41 is driven to control movement of the medium P along the transport direction. The control signal Ctrl-T may be input to the transport motor 41 after being converted into a signal through a driver circuit (not illustrated).

In addition, the control circuit 100 generates printing data signals SI1 to SI4, a change signal CH, a latch signal LAT, and a clock signal SCK, as a control signal Ctrl-H for controlling the print heads 21 included in the head unit 20 based on the image information signal input from the external device and a transport position along the transport direction of the medium P; and outputs the signals to the print heads 21 included in the head unit 20.

In addition, the control circuit 100 outputs base drive signals dA1 and dB1 that are digital signals, to the drive circuit 50-1 as the control signal Ctrl-H. The drive circuit 50-1 generates a drive signal COMA1 as the drive signal COM by performing digital/analog signal conversion on the input base drive signal dA1 and then performing class-D amplification of the converted analog signal in response to the voltage signal VHV; and generates a drive signal COMB1 as the drive signal COM by performing digital/analog signal conversion on the input base drive signal dB1 and then performing class-D amplification of the converted analog signal in response to the voltage signal VHV. In addition, the drive circuit 50-1 generates a reference voltage signal VBS1 having a constant voltage value as the reference voltage signal VBS by, for example, stepping down or stepping up the voltage signal VDD1 that is a power supply voltage having a predetermined voltage value. The reference voltage signal VBS1 generated by the drive circuit 50-1 may be a signal of a ground potential. The drive circuit 50-1 outputs the generated drive signals COMA1 and COMB1 and reference voltage signal VBS1 to the print head 21 included in the head unit 20. That is, the drive circuit 50-1 includes a class-D amplification circuit that outputs the drive signal COMA1 corresponding to the base drive signal dA1, a class-D amplification circuit that outputs the drive signal COMB1 corresponding to the base drive signal dB1, and a DC/DC converter that outputs the reference voltage signal VBS1.

Similarly, the control circuit 100 outputs base drive signals dA2 to dA4 and dB2 to dB4 that are digital signals, to each of the drive circuits 50-2 to 50-4 as the control signal Ctrl-H. The respective drive circuits 50-2 to 50-4 generate drive signals COMA2 to COMA4 as the drive signal COM by performing digital/analog signal conversion on the input base drive signals dA2 to dA4 and then performing class-D amplification of the converted analog signal in response to the voltage signal VHV; and generate drive signals COMB2 to COMB4 as the drive signal COM by performing digital/analog signal conversion on the input base drive signals dB2 to dB4 and then performing class-D amplification of the converted analog signal in response to the voltage signal VHV. In addition, the respective drive circuits 50-2 to 50-4 generate reference voltage signals VBS2 to VBS4 having a constant voltage value as the reference voltage signal VBS by, for example, stepping down or stepping up the voltage signal VDD1 that is a power supply voltage having a predetermined voltage value. The reference voltage signals VBS2 to VBS4 generated by the drive circuits 50-2 to 50-4 may be a signal of a ground potential. The respective drive circuits 50-2 to 50-4 output the generated drive signals COMA2 to COMA4 and COMB2 to COMB4 and reference voltage signals VBS2 to VBS4 to the print heads 21 included in the head unit 20.

Here, the base drive signals dA1 to dA4 and dB1 to dB4, output from the control circuit 100, are described as digital signals that define signal waveforms of the corresponding drive signals COMA1 to COMA4 and COMB1 to COMB4; but the base drive signals dA1 to dA4 and dB1 to dB4 may be analog signals as long as the signal waveforms of the corresponding drive signals COMA1 to COMA4 and COMB1 to COMB4 can be defined. In addition, the drive circuits 50-1 to 50-4 may generate the drive signals COMA1 to COMA4 and COMB1 to COMB4 by performing class-A amplification, class-B amplification, or class-AB amplification, instead of or in addition to the class-D amplification of the signal waveforms defined by the base drive signals dA1 to dA4 and dB1 to dB4.

The print head 21 includes ejecting heads 22-1 to 22-4. Each of the ejecting heads 22-1 to 22-4 includes a temperature abnormality detection circuit 400, a drive signal selection circuit 200, and a plurality of ejecting portions 600, and each of the plurality of ejecting portions 600 includes a piezoelectric element 60.

A plurality of signals including the printing data signal SI1, the change signal CH, the latch signal LAT, and the clock signal SCK that output from the control circuit 100, the drive signals COMA1 and COMB1 and the reference voltage signal VBS1 that output from the drive circuit 50-1, and the voltage signals VHV, VDD1, and VDD2 that output from the power supply circuit 70 are input to the ejecting head 22-1.

The clock signal SCK, the latch signal LAT, the change signal CH, the printing data signal SI1, and the drive signals COMA1 and COMB1, which input to the ejecting head 22-1, are input to the drive signal selection circuit 200. The drive signal selection circuit 200 selects or does not select the signal waveforms of the drive signals COMA1 and COMB1 based on the input clock signal SCK, latch signal LAT, change signal CH, and printing data signal SI1, to generate a drive signal VOUT corresponding to each of the plurality of piezoelectric elements 60. The drive signal selection circuit 200 outputs the generated drive signal VOUT to one end of the corresponding piezoelectric element 60. In addition, the reference voltage signal VBS1 is commonly supplied to the other ends of the plurality of piezoelectric elements 60. Each of the plurality of piezoelectric elements 60 is driven by a potential difference between the drive signal VOUT supplied to one end and the reference voltage signal VBS1 supplied to the other end. The ink is ejected from the ejecting portion 600 in an amount corresponding to the driving of the piezoelectric element 60.

The temperature abnormality detection circuit 400 is located in the vicinity of the drive signal selection circuit 200, and detects whether or not temperature abnormality occurs in the drive signal selection circuit 200. The temperature abnormality detection circuit 400 generates a temperature state signal XHOT1 corresponding to the temperature of the drive signal selection circuit 200, and outputs the temperature state signal XHOT1 from the ejecting head 22-1.

Here, the ejecting heads 22-2 to 22-4 have the same configuration as the ejecting head 22-1 and execute the same operation as the ejecting head 22-1, except that the input signals and the output signals are different. That is, a plurality of signals including the clock signal SCK, the latch signal LAT, the change signal CH, the printing data signal SIi, the drive signals COMAi and COMBi, the reference voltage signal VBSi, and the voltage signals VHV, VDD1, and VDD2 are input to the ejecting head 22-i (i is any one of 1 to 4). The drive signal selection circuit 200 included in the ejecting head 22-i selects or does not select the signal waveforms of the drive signals COMAi and COMBi based on the input clock signal SCK, latch signal LAT, change signal CH, and printing data signal SIi, to generate a drive signal VOUT corresponding to each of the plurality of piezoelectric elements 60.

The drive signal VOUT generated by the drive signal selection circuit 200 is supplied to one end of the corresponding piezoelectric element 60. In addition, the reference voltage signal VBSi is commonly supplied to the other ends of the plurality of piezoelectric elements 60 included in the ejecting head 22-i. As a result, each of the plurality of piezoelectric elements 60 included in the ejecting head 22-i is driven, and an amount of ink corresponding to the driving of the piezoelectric element 60 is ejected from the corresponding ejecting portion 600.

In addition, the temperature abnormality detection circuit 400 included in the ejecting head 22-i is located in the vicinity of the drive signal selection circuit 200 included in the ejecting head 22-i, and detects whether or not temperature abnormality occurs in the drive signal selection circuit 200. The temperature abnormality detection circuit 400 generates a temperature state signal XHOTi corresponding to the temperature of the drive signal selection circuit 200, and outputs the temperature state signal XHOTi from the ejecting head 22-i.

Here, the temperature state signals XHOT1 to XHOT4 output from the temperature abnormality detection circuits 400 included in the respective ejecting heads 22-1 to 22-4 are propagated through a common wiring pattern in the print head 21, and are output from the print head 21 as the temperature state signals XHOT.

The temperature state signals XHOT output from the print head 21 are input to the control circuit 100. The control circuit 100 determines whether or not the temperature abnormality occurs in the print head 21 based on the input temperature state signals XHOT. The control circuit 100 corrects or stops the output of the various signals in response to the presence or absence of the temperature abnormality in the print head 21. As a result, reliability of the liquid ejecting apparatus 1 is improved.

Here, in the following description, when it is not necessary to distinguish between the ejecting heads 22-1 to 22-4, the ejecting heads 22-1 to 22-4 may be simply referred to as an ejecting head 22. In this case, the ejecting head 22 is described as a configuration in which the clock signal SCK, the latch signal LAT, the change signal CH, the printing data signal SI, the drive signals COMA and COMB, and the reference voltage signal VBS are input, and the temperature state signal XHOT is output.

### 2. Function and configuration of print head

### 2.1. Configuration of drive signal selection circuit

As described above, the drive signal selection circuit 200 generates the drive signals VOUT corresponding to the respective ejecting portions 600 by selecting or not selecting the signal waveforms of the input drive signals COMA and COMB, and outputs the drive signals VOUT to the piezoelectric elements 60 included in the corresponding ejecting portions 600. Therefore, in describing the configuration of the drive signal selection circuit 200, first, an example of signal waveforms of the drive signals COMA and COMB input to the drive signal selection circuit 200, and an example of a signal waveform of the drive signal VOUT output from the drive signal selection circuit 200 will be described.

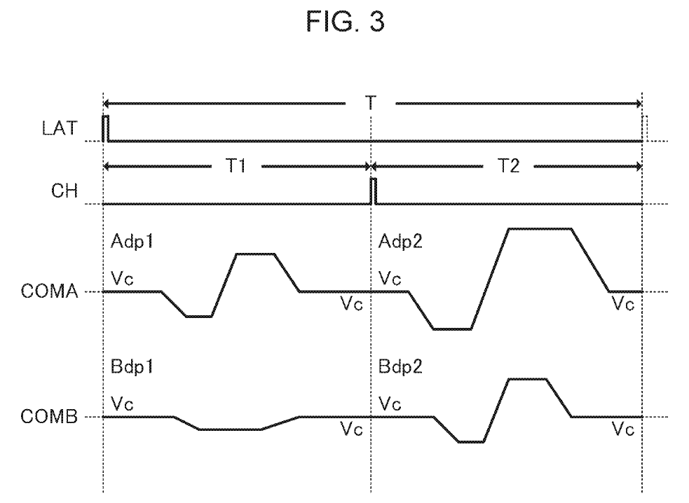

FIG. 3 is a view illustrating an example of the signal waveforms of the drive signals COMA and COMB. As illustrated in FIG. 3, the drive signal COMA has a trapezoidal waveform Adp1 disposed in a period T1 from the rise of the latch signal LAT to the rise of the change signal CH, and a trapezoidal waveform Adp2 disposed in a period T2 from the rise of the change signal CH to the rise of the latch signal LAT. In addition, when the trapezoidal waveform Adp1 is supplied to one end of the piezoelectric element 60, a predetermined amount of ink is ejected from the ejecting portion 600 that corresponds to the piezoelectric element 60, and the trapezoidal waveform Adp2 is supplied to one end of the piezoelectric element 60, an amount of ink larger than a predetermined amount is ejected from the ejecting portion 600 that corresponds to the piezoelectric element 60.

The drive signal COMB has a trapezoidal waveform Bdp1 disposed in the period T1 and a trapezoidal waveform Bdp2 disposed in the period T2. Even when the trapezoidal waveform Bdp1 is supplied to one end of the piezoelectric element 60, no ink is ejected from the ejecting portion 600 that corresponds to the piezoelectric element 60. The trapezoidal waveform Bdp1 is a signal waveform for vibrating the ink in the vicinity of a nozzle opening portion of the ejecting portion 600 to prevent an increase in ink viscosity. In addition, when the trapezoidal waveform Bdp2 is supplied to one end of the piezoelectric element 60, a predetermined amount of ink is ejected from the ejecting portion 600 that corresponds to the piezoelectric element 60 in the same manner as when the trapezoidal waveform Adp1 is supplied.

In the trapezoidal waveforms Adp1, Adp2, Bdp1, and Bdp2, voltages at the start timing and the end timing of each of the trapezoidal waveforms are all the same voltage Vc. In other words, each of the trapezoidal waveforms Adp1, Adp2, Bdp1, and Bdp2 starts at the voltage Vc and ends at the voltage Vc.

Here, in the following description, when the trapezoidal waveform Adp1 is supplied to one end of the piezoelectric element 60 and the trapezoidal waveform Bdp2 is supplied to one end of the piezoelectric element 60, a predetermined amount of ink ejected from the ejecting portion 600 that corresponds to the piezoelectric element 60 may be referred to as a small amount. When the trapezoidal waveform Adp2 is supplied to one end of the piezoelectric element 60, the amount of ink ejected from the ejecting portion 600 that corresponds to the piezoelectric element 60, which is larger than the predetermined amount, may be referred to as an intermediate amount. In addition, when the trapezoidal waveform Bdp1 is supplied to one end of the piezoelectric element 60, the operation for vibrating the ink in the vicinity of the nozzle opening portion of the ejecting portion 600 that corresponds to the piezoelectric element 60 to prevent the ink viscosity from increasing may be referred to as micro-vibration BSD.

Although FIG. 3 illustrates a case where the trapezoidal waveform Adp1 and the trapezoidal waveform Bdp2 have signal waveforms having the same shape, the trapezoidal waveform Adp1 and the trapezoidal waveform Bdp2 may have different signal waveforms. In addition, in the following description, it is described that a small amount of ink is ejected from the corresponding ejecting portion 600 both when the trapezoidal waveform Adp1 is supplied to the piezoelectric element 60 and when the trapezoidal waveform Bdp2 is supplied to the piezoelectric element 60, but the present disclosure is not limited thereto. In other words, the signal waveforms of the drive signals COMA and COMB are not limited to the signal waveforms having the shape illustrated in FIG. 3, and signals of various waveform combinations may be used according to the nature of the ejected ink, the material of the recording medium, or the like. Therefore, the signal waveforms of the drive signals COMA1 to COMA4 are not limited to the signal waveforms illustrated in FIG. 3, and the signal waveforms of the drive signals COMA1 to COMA4 may have different waveform shapes. Similarly, the signal waveforms of the drive signals COMB1 to COMB4 are not limited to the signal waveforms illustrated in FIG. 3, and the signal waveforms of the drive signals COMB1 to COMB4 may have different waveform shapes.

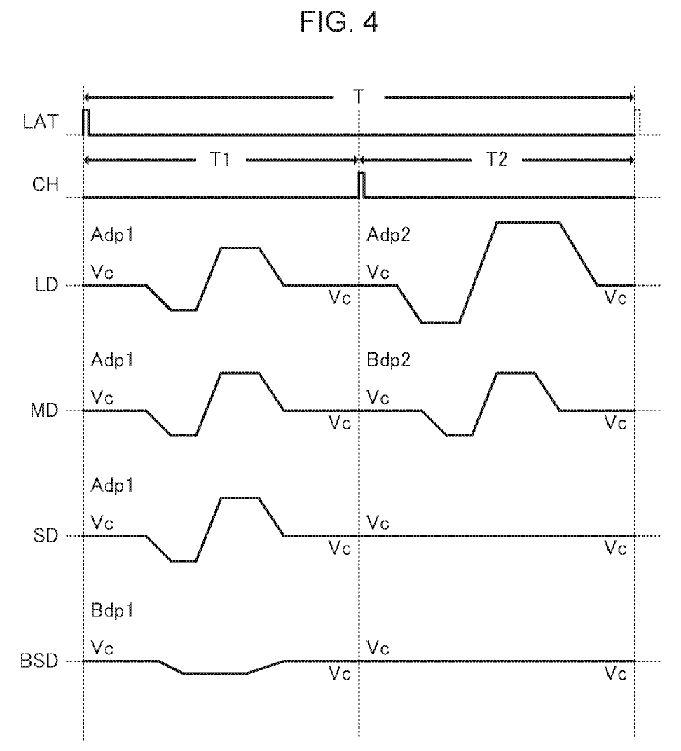

FIG. 4 is a view illustrating an example of the waveform of the drive signal VOUT that corresponds to each of “large dot LD”, “medium dot MD”, “small dot SD”, and “micro-vibration BSD” formed at the medium P.

As illustrated in FIG. 4, the drive signal VOUT for forming the “large dot LD” on the medium P has a signal waveform in which the trapezoidal waveform Adp1 disposed in the period T1 and the trapezoidal waveform Adp2 disposed in the period T2 are continuous. When the drive signal VOUT is supplied to one end of the piezoelectric element 60, a small amount of ink and a medium amount of ink are ejected from the ejecting portion 600 that corresponds to the piezoelectric element 60. The large dot LD is formed at the medium P by the respective inks landing on and bonding onto the medium P.

The drive signal VOUT for forming the “medium dot MD” on the medium P has a signal waveform in which the trapezoidal waveform Adp1 disposed in the period T1 and the trapezoidal waveform Bdp2 disposed in the period T2 are continuous. When the drive signal VOUT is supplied to one end of the piezoelectric element 60, a small amount of ink is ejected two times from the ejecting portion 600 that corresponds to the piezoelectric element 60. The medium dot MD smaller than the large dot LD is formed at the medium P by the respective inks landing on and bonding onto the medium P.

The drive signal VOUT for forming the “small dot SD” on the medium P has a signal waveform in which the trapezoidal waveform Adp1 disposed in the period T1 and a waveform in which the voltage value in the period T2 is the constant voltage Vc are continuous. When the drive signal VOUT is supplied to one end of the piezoelectric element 60, a small amount of ink is ejected one time from the ejecting portion 600 that corresponds to the piezoelectric element 60. The small dot SD smaller than the medium dot MD is formed at the medium P by the ejected ink landing on the medium P.

The drive signal VOUT that corresponds to the “micro-vibration BSD” has a signal waveform in which the trapezoidal waveform Bdp1 disposed in the period T1 and a waveform in which the voltage value in the period T2 is the constant voltage Vc are continuous. When the drive signal VOUT is supplied to one end of the piezoelectric element 60, the ink in the vicinity of the nozzle opening portion of the ejecting portion 600 that corresponds to the piezoelectric element 60 vibrates only, and no ink is ejected from the ejecting portion 600. Therefore, during the period in which the micro-vibration BSD is executed, the ink does not land on the medium P, and the dot is not formed at the medium P.

Here, in the waveform in which the voltage value included in the drive signal VOUT is the constant voltage Vc, when the drive signal selection circuit 200 selects none of the trapezoidal waveforms Adp1, Adp2, Bdp1, and Bdp2 as the drive signal VOUT, a signal waveform obtained when a signal in which the voltage value supplied to the piezoelectric element 60 immediately before is the constant voltage Vc is held by a capacitance component of the piezoelectric element 60.

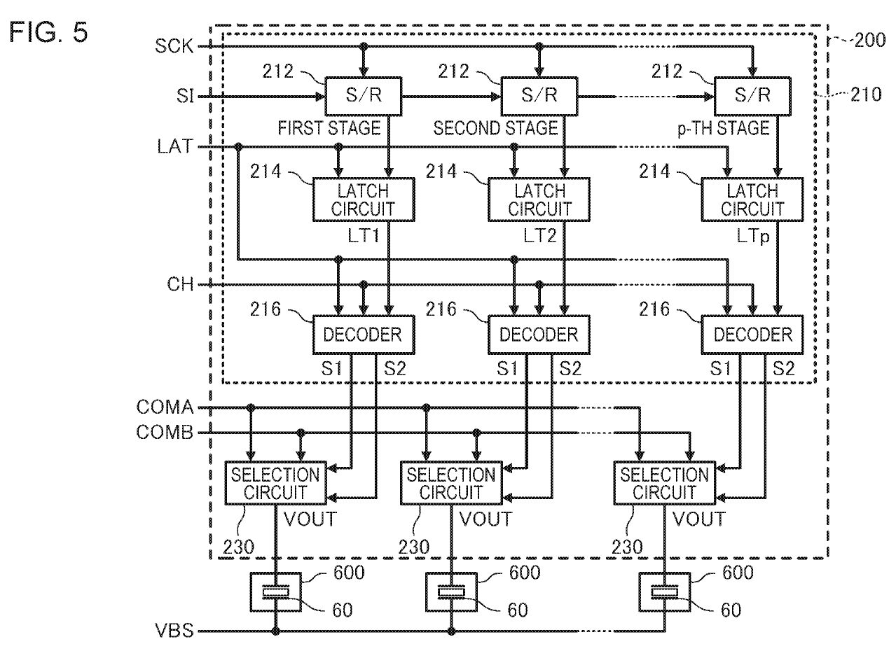

Next, a configuration and an operation of the drive signal selection circuit 200 that outputs the drive signal VOUT by selecting or not selecting the drive signals COMA and COMB will be described. Here, in the following description, a case where the drive signal selection circuit 200 generates and outputs the drive signal VOUT corresponding to each of p ejecting portions 600 as the plurality of ejecting portions 600 will be described as an example. FIG. 5 is a view illustrating the configuration of the drive signal selection circuit 200. As illustrated in FIG. 5, the drive signal selection circuit 200 includes a selection control circuit 210 and p selection circuits 230.

The printing data signal SI, the latch signal LAT, the change signal CH, and the clock signal SCK, which are output from the control circuit 100, are input to the selection control circuit 210. In the selection control circuit 210, sets of a shift register (S/R) 212, a latch circuit 214, and a decoder 216 are provided corresponding to each of p ejecting portions 600. That is, the drive signal selection circuit 200 includes p shift registers 212, p latch circuits 214, and p decoders 216.

The printing data signal SI is input to the selection control circuit 210 in synchronization with the clock signal SCK. The printing data signals SI are 2-bit printing data [SIH, SIL] for selecting one of the “large dot LD”, the “medium dot MD”, the “small dot SD”, and the “micro-vibration BSD”, serially corresponding to each of the p ejecting portions 600. That is, the printing data signal SI is a signal of 2p bits or more. The printing data [SIH, SIL] included in the printing data signal SI is held in the p shift registers 212 that corresponds to the p ejecting portions 600. Specifically, p-th stages of the shift register 212 corresponding to the ejecting portions 600 are continuously coupled to each other, and the serially input printing data signals SI are sequentially transferred to the subsequent stage among p-th stages of the shift register 212, which are continuously coupled to each other, in accordance with the clock signal SCK. When the printing data [SIH, SIL] is held in the corresponding shift register 212, the clock signal SCK is stopped. In other words, by stopping the supply of the clock signal SCK, the printing data [SIH, SIL] included in the printing data signal SI is held in the corresponding shift register 212. In FIG. 5, in order to distinguish between the p shift registers 212, the shift registers 212 are denoted as a first stage, a second stage, ..., p-th stage in order from upstream where the printing data signal SI is input.

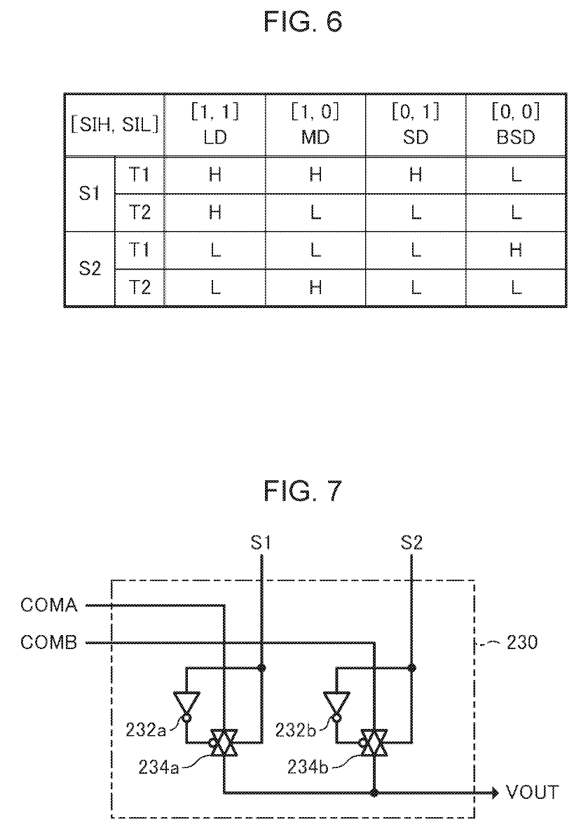

Each of the p latch circuits 214 latches the printing data [SIH, SIL] held in each of the p shift registers 212 all at once at the rise of the latch signal LAT. The printing data [SIH, SIL] latched by the latch circuit 214 is input to the corresponding decoder 216. FIG. 6 is a diagram illustrating an example of decoding contents in the decoder 216. The decoder 216 generates a signal of a logic level in response to the latched printing data [SIH, SIL] in each of the periods T1 and T2. The decoder 216 level-shifts the generated signal to a high-amplitude logic signal in response to the voltage signal VHV, and outputs the level-shifted signal as selection signals S1 and S2. For example, when the printing data [SIH, SIL] = [1, 0] is input, the decoder 216 outputs the selection signal S1 having H and L levels in the periods T1 and T2 and the selection signal S2 having L and H levels in the periods T1 and T2.

The selection signals S1 and S2 output from the decoder 216 are input to the selection circuit 230. The selection circuit 230 is provided corresponding to each of the p ejecting portions 600. In other words, the drive signal selection circuit 200 has p selection circuits 230 that are the same in number as the p ejecting portions 600. FIG. 7 is a view illustrating a configuration of the selection circuit 230 that corresponds to one ejecting portion 600. As illustrated in FIG. 7, the selection circuit 230 has inverters 232a and 232b, which are NOT circuits, and transfer gates 234a and 234b.

The selection signal S1 is input to a positive control end, which is not marked with a circle, at the transfer gate 234a, and after the logic level thereof is inverted by the inverter 232a, the selection signal S1 is input to a negative control end marked with a circle at the transfer gate 234a. The drive signal COMA is supplied to the input end of the transfer gate 234a. In addition, the transfer gate 234a conducts the input end and the output end to each other when the logic level of the selection signal S1 is the H level, and does not conduct the input end and the output end to each other when the logic level of the selection signal S1 is the L level. That is, the transfer gate 234a outputs the signal waveform included in the drive signal COMA from the output end when the logic level of the selection signal S1 is the H level, and does not output the signal waveform included in the drive signal COMA from the output end when the logic level of the selection signal S1 is the L level.

The selection signal S2 is input to a positive control end, which is not marked with a circle, at the transfer gate 234b, and after the logic level thereof is inverted by the inverter 232b, the selection signal S2 is input to a negative control end marked with a circle at the transfer gate 234b. The drive signal COMB is supplied to the input end of the transfer gate 234b. In addition, the transfer gate 234b conducts the input end and the output end to each other when the logic level of the selection signal S2 is the H level, and does not conduct the input end and the output end to each other when the logic level of the selection signal S2 is the L level. That is, the transfer gate 234b outputs the signal waveform included in the drive signal COMB from the output end when the logic level of the selection signal S2 is the H level, and does not output the signal waveform included in the drive signal COMB from the output end when the logic level of the selection signal S2 is the L level.

The output ends of the transfer gates 234a and 234b configured as described above are commonly coupled in the selection circuit 230. The drive signal selection circuit 200 outputs the signals at the output ends of the transfer gates 234a and 234b commonly coupled in the selection circuit 230, as the drive signal VOUT.

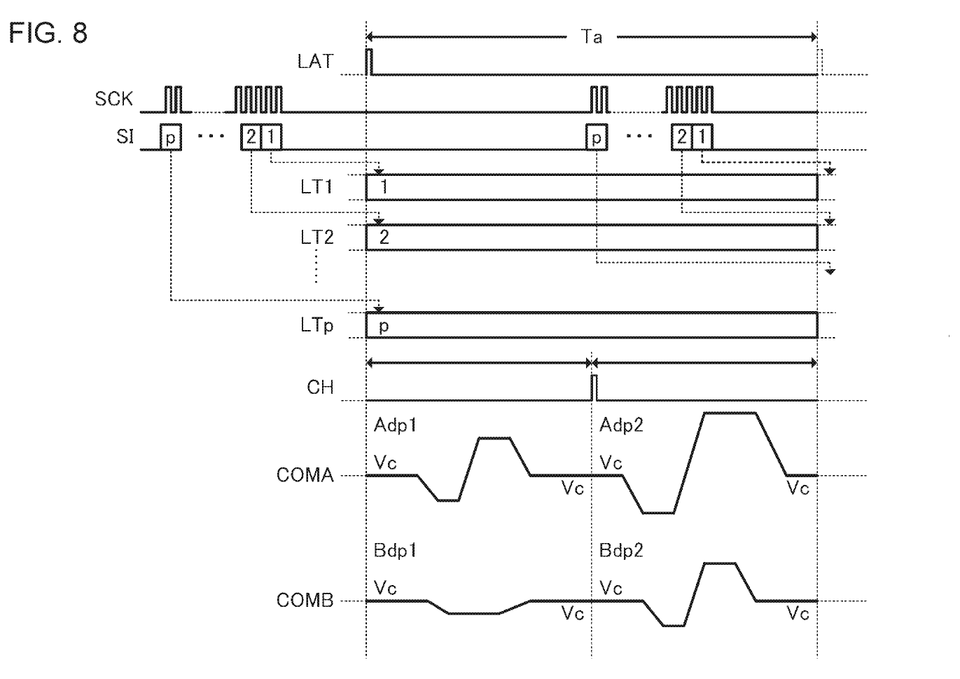

The operation of the drive signal selection circuit 200 will be described with reference to FIG. 8. FIG. 8 is a view for describing the operation of the drive signal selection circuit 200. The printing data signal SI is serially input in synchronization with the clock signal SCK. In addition, the printing data signals SI are sequentially transferred in the p shift registers 212 that correspond to the p ejecting portions 600 in synchronization with the clock signal SCK. Thereafter, when the input of the clock signal SCK is stopped, the printing data [SIH, SIL] that corresponds to each of the p ejecting portions 600 is held in the shift registers 212. The printing data signal SI is input in order corresponding to the p-th stage, ..., second stage, and first stage ejecting portions 600 of the shift register 212.

In addition, when the latch signal LAT rises, each of the latch circuits 214 latches the printing data [SIH, SIL] held in the shift register 212 all at once. LT1, LT2, ..., and LTp illustrated in FIG. 8 indicate the printing data [SIH, SIL] latched by the latch circuits 214 corresponding to the first stage, second stage, ..., and p-th stage shift registers 212.

The decoder 216 outputs the logic levels of the selection signals S1 and S2 in each of the periods T1 and T2 with the contents illustrated in FIG. 6, according to the size of the dot defined by the latched printing data [SIH, SIL]. The selection circuit 230 selects or does not select the signal waveforms included in the drive signals COMA and COMB according to the logic levels of the selection signals S1 and S2 output from the decoder 216, thereby generating the drive signal VOUT.

Specifically, when the printing data [SIH, SIL] = [1, 1] is input to the decoder 216, the decoder 216 sets the logic level of the selection signal S1 to the H and H levels in the periods T1 and T2, and sets the logic level of the selection signal S2 to the L and L levels in the periods T1 and T2. Accordingly, the selection circuit 230 selects the trapezoidal waveform Adp1 in the period T1 and selects the trapezoidal waveform Adp2 in the period T2. As a result, the drive signal selection circuit 200 outputs the drive signal VOUT that corresponds to the “large dot LD” illustrated in FIG. 4.

In addition, when the printing data [SIH, SIL] = [1, 0] is input to the decoder 216, the decoder 216 sets the logic level of the selection signal S1 to the H and L levels in the periods T1 and T2, and sets the logic level of the selection signal S2 to the L and H levels in the periods T1 and T2. Accordingly, the selection circuit 230 selects the trapezoidal waveform Adp1 in the period T1 and selects the trapezoidal waveform Bdp2 in the period T2. As a result, the drive signal selection circuit 200 outputs the drive signal VOUT that corresponds to the “medium dot MD” illustrated in FIG. 4.

In addition, when the printing data [SIH, SIL] = [0, 1] is input to the decoder 216, the decoder 216 sets the logic level of the selection signal S1 to the H and L levels in the periods T1 and T2, and sets the logic level of the selection signal S2 to the L and L levels in the periods T1 and T2. Accordingly, the selection circuit 230 selects the trapezoidal waveform Adp1 in the period T1 and selects none of the trapezoidal waveforms Adp2 and Bdp2 in the period T2. As a result, the drive signal selection circuit 200 outputs the drive signal VOUT that corresponds to the “small dot SD” illustrated in FIG. 4.

In addition, when the printing data [SIH, SIL] = [0, 0] is input to the decoder 216, the decoder 216 sets the logic level of the selection signal S1 to the L and L levels in the periods T1 and T2, and sets the logic level of the selection signal S2 to the H and L levels in the periods T1 and T2. Accordingly, the selection circuit 230 selects the trapezoidal waveform Bdp1 in the period T1 and selects none of the trapezoidal waveforms Adp2 and Bdp2 in the period T2. As a result, the drive signal selection circuit 200 outputs the drive signal VOUT that corresponds to the “micro-vibration BSD” illustrated in FIG. 4.

The drive signal selection circuit 200 configured as described above is driven using the voltage signal VDD1 output from the power supply circuit 70 as a power supply voltage; generates the drive signal VOUT corresponding to each of the “large dot LD”, the “medium dot MD”, the “small dot SD”, and the “micro-vibration BSD” corresponding to each of the p ejecting portions 600 by selecting or not selecting the trapezoidal waveforms Adp1 and Adp2 included in the drive signal COMA and the trapezoidal waveforms Bdp1 and Bdp2 included in the drive signal COMB based on the input printing data signal SI, the latch signal LAT, the change signal CH, and the clock signal SCK; and outputs the drive signal VOUT to each of the p ejecting portions 600.

In this case, the voltage signal VDD1 is supplied to the drive signal selection circuit 200 that controls the supply of the drive signals COMA and COMB to the piezoelectric element 60 as the power supply voltage, and the printing data signal SI, the latch signal LAT, the change signal CH, and the clock signal SCK define the waveform selection in the drive signals COMA and COMB in the drive signal selection circuit 200.

### 2.2. Configuration of temperature abnormality detection circuit

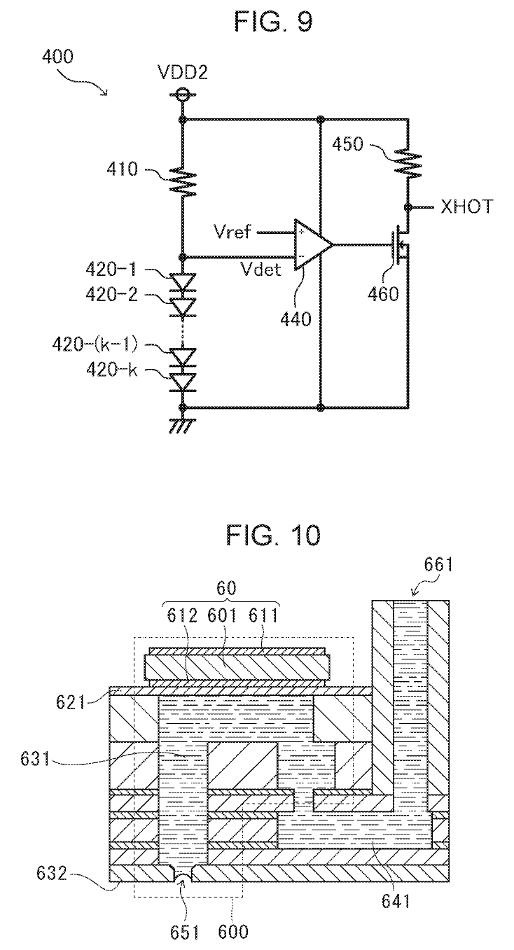

Next, a specific example of a configuration and an operation of the temperature abnormality detection circuit 400 will be described. FIG. 9 is a view illustrating an example of a configuration of the temperature abnormality detection circuit 400. As illustrated in FIG. 9, the temperature abnormality detection circuit 400 includes diodes 420-1 to 420-k, a comparator 440, a transistor 460, and resistors 410 and 450. The temperature abnormality detection circuit 400 is configured as, for example, an integrated circuit device, and is disposed in the vicinity of the drive signal selection circuit 200 described above. In this case, the integrated circuit device constituting the temperature abnormality detection circuit 400 and an integrated circuit device constituting the drive signal selection circuit 200 may be the same integrated circuit device. In other words, the temperature abnormality detection circuit 400 and the drive signal selection circuit 200 may be mounted on one integrated circuit device.

The voltage signal VDD2 having a constant voltage value is supplied to the temperature abnormality detection circuit 400. The voltage signal VDD2 supplied to the temperature abnormality detection circuit 400 is input to one end of the resistor 410 and one end of the resistor 450. The other end of the resistor 410 is electrically connected to an anode terminal of the diode 420-1. A cathode terminal of the diode 420-1 is electrically connected to an anode terminal of the diode 420-2; a cathode terminal of the diode 420-2 is electrically connected to an anode terminal of the diode 420-3; and a cathode terminal of a diode 420-j (j is any one of 1 to k-1) is electrically connected to an anode terminal of a diode 420-(j+1). That is, the diodes 420-1 to 420-k are connected in series. In this case, the anode terminal of the diode 420-1 provided at one end of the diodes 420-1 to 420-k connected in series is electrically connected to the other end of the resistor 410, and the cathode terminal of the diode 420-k provided at the other end of the diodes 420-1 to 420-k connected in series is supplied with a ground potential. A signal of a connection point at which the other end of the resistor 410 and the anode terminal of the diode 420-1 are electrically connected, which is a signal having a voltage value that is a sum of forward voltages of the diodes 420-1 to 420-k connected in series, is input to a negative input terminal of the comparator 440 as a voltage signal Vdet.

In addition, a voltage signal Vref is input to a positive input terminal of the comparator 440. The voltage signal Vref may be generated based on, for example, a band gap reference of the integrated circuit device included in the temperature abnormality detection circuit 400, or may be generated by stepping down the voltage signal VDD2 supplied to the temperature abnormality detection circuit 400.

The comparator 440 operates using a potential difference between the voltage signal VDD2 supplied to the high potential-side power supply terminal and the signal of the ground potential supplied to the low potential-side power supply terminal, as a drive source. An output terminal of the comparator 440 is electrically connected to a gate terminal of the transistor 460. A drain terminal of the transistor 460 is electrically connected to the other end of the resistor 450, and the ground potential is supplied to a source terminal of the transistor 460. The signal of the drain terminal of the transistor 460 is output from the temperature abnormality detection circuit 400 as the temperature state signal XHOT.

In the temperature abnormality detection circuit 400 configured as described above, the voltage values of the forward voltages of the diodes 420-1 to 420-k decrease when temperatures of the diodes 420-1 to 420-k increase. That is, the voltage value of the voltage signal Vdet changes depending on the temperature of the diodes 420-1 to 420-k, which is the temperature of the drive signal selection circuit 200 located in the vicinity of the diodes 420-1 to 420-k. The voltage signal Vdet in which the voltage value changes depending on the temperature is input to the negative input terminal of the comparator 440.

The comparator 440 compares the voltage value of the voltage signal Vref input to the positive input terminal with the voltage value of the voltage signal Vdet input to the negative input terminal. The comparator 440 outputs a signal having a voltage value that is the L level of the ground potential when the voltage value of the voltage signal Vdet is larger than the voltage value of the voltage signal Vref, and outputs a signal having a voltage value that is the H level of the voltage signal VDD2 when the voltage value of the voltage signal Vdet is smaller than the voltage value of the voltage signal Vref.

Here, the voltage value of the voltage signal Vref is set to, for example, the voltage value of the voltage signal Vdet input to the comparator 440 when the temperature of the drive signal selection circuit 200 is the highest in a temperature range in which the drive signal selection circuit 200 can stably operate. That is, the comparator 440 outputs a signal having the L level when the temperature of the drive signal selection circuit 200 is within the temperature range in which the drive signal selection circuit 200 can stably operate, and a signal having the H level when the temperature of the drive signal selection circuit 200 exceeds the temperature range in which the drive signal selection circuit 200 can stably operate. The voltage value of the voltage signal Vref input to the comparator 440 is not defined based only on the temperature of the drive signal selection circuit 200, and may be defined by comprehensively taking into account the temperatures of other configurations.

The signal output from the comparator 440 is input to the gate terminal of the transistor 460. When a signal having the H level is input to the gate terminal, the transistor 460 is in conduction between the drain terminal and the source terminal. In this case, the temperature abnormality detection circuit 400 outputs the temperature state signal XHOT having the L level. On the other hand, when a signal having the L level is input to the gate terminal, the transistor 460 is in non-conduction between the drain terminal and the source terminal. In this case, the temperature abnormality detection circuit 400 outputs the temperature state signal XHOT having the H level.

That is, the temperature abnormality detection circuit 400 outputs the temperature state signal XHOT having the L level when the temperature of the drive signal selection circuit 200 is outside the temperature range in which the drive signal selection circuit 200 can stably operate, and outputs the temperature state signal XHOT having the H level when the temperature of the drive signal selection circuit 200 is within the temperature range in which the drive signal selection circuit 200 can stably operate. In other words, the temperature abnormality detection circuit 400 outputs the temperature state signal XHOT having the L level when the temperature of the corresponding drive signal selection circuit 200 is abnormal, and outputs the temperature state signal XHOT having the H level when the temperature of the corresponding drive signal selection circuit 200 is normal.

Here, as illustrated in FIG. 2, a wiring through which the temperature state signals XHOT1 to XHOT4 output from the respective ejecting heads 22-1 to 22-4 are propagated is commonly connected in the print head 21. Therefore, when the temperature abnormality occurs in any temperature abnormality detection circuit 400 included in the respective ejecting heads 22-1 to 22-4, the logic levels of the temperature state signals XHOT1 to XHOT4 output from the respective ejecting heads 22-1 to 22-4 are all at the L level. That is, the temperature state signals XHOT1 to XHOT4 output from the temperature abnormality detection circuit 400 included in the respective ejecting heads 22-1 to 22-4 are wired and connected in the print head 21, and are output from the print head 21 as the temperature state signal XHOT. Therefore, the print head 21 outputs the temperature state signal XHOT having the L level indicating the abnormality when any of the temperature state signals XHOT1 to XHOT4 indicates the abnormality, and outputs the temperature state signal XHOT having the H level indicating the normality when all of the temperature state signals XHOT1 to XHOT4 indicate the normality.

That is, the voltage signal VDD1 is supplied to the temperature abnormality detection circuit 400 that outputs the temperature state signal XHOT corresponding to the temperature of the print head 21. In this case, it is preferable that the voltage signal VDD2 input to the temperature abnormality detection circuit 400 is not input to the configuration other than the plurality of temperature abnormality detection circuits 400 included in the head unit 20. As described above, the temperature abnormality detection circuit 400 determines whether or not the temperature is normal based on the voltage values of the forward voltages of the diodes 420-1 to 420-k, which change depending on the temperature. In this case, an amount of change in the voltage value of the forward voltage generated in each of the diodes 420-1 to 420-k is small, and thus, when, for example, noise is superimposed on the power supply voltage input to the temperature abnormality detection circuit 400 or the voltage value fluctuates, the accuracy of the determination result of the presence or absence of the temperature abnormality in the temperature abnormality detection circuit 400 is reduced. By not inputting the voltage signal VDD2 input as the power supply voltage to the temperature abnormality detection circuit 400 to the configuration other than the temperature abnormality detection circuit 400, the possibility that the noise is superimposed on the voltage signal VDD2 is reduced, and thus the possibility that the voltage value of the voltage signal VDD2 fluctuates is reduced. As a result, a signal accuracy of the temperature state signal XHOT output from the temperature abnormality detection circuit 400 is improved.

### 3. Structure of print head

### 3.1. Structure of ejecting portion

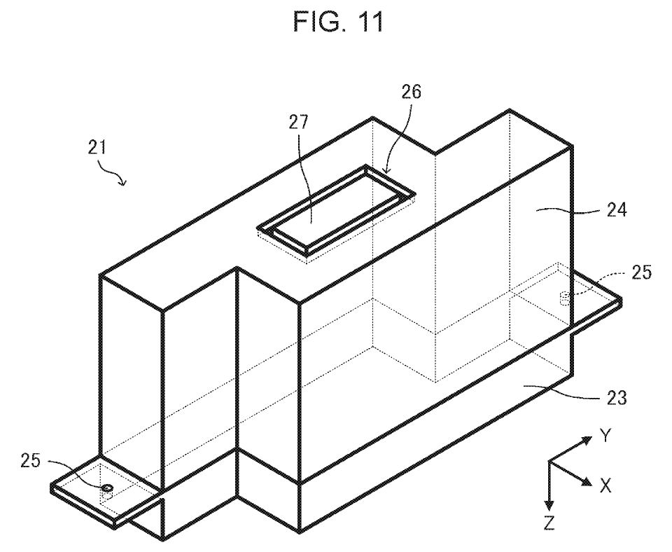

First, a structure of the plurality of ejecting portions 600 included in the print head 21 will be described. FIG. 10 is a view illustrating an example of a structure of the ejecting portion 600. As illustrated in FIG. 10, the ejecting portion 600 includes a piezoelectric element 60, a vibrating plate 621, a cavity 631, and a nozzle 651.

The cavity 631 is filled with the ink supplied from a reservoir 641. In addition, the ink is introduced into the reservoir 641 from the ink container 90 through an ink tube (not illustrated) and a supply port 661. That is, the cavity 631 is filled with the ink that is stored in the corresponding ink container 90.

The vibrating plate 621 is displaced by the driving of the piezoelectric element 60 provided on the upper surface in FIG. 10. In addition, the internal volume of the cavity 631 filled with the ink is expanded and reduced in association with the displacement of the vibrating plate 621. That is, the vibrating plate 621 functions as a diaphragm that changes the internal volume of the cavity 631.

The nozzle 651 is an opening which is provided on a nozzle plate 632 and communicates with the cavity 631. When the internal volume of the cavity 631 changes, the ink is ejected from the nozzle 651 in an amount corresponding to the change in internal volume.

The piezoelectric element 60 has a structure in which a piezoelectric body 601 is interposed between a pair of electrodes 611 and 612. In the piezoelectric body 601 having such a structure, the central portions of the electrodes 611 and 612 bend in the vertical direction together with the vibrating plate 621 according to the potential difference of the signals supplied to the electrodes 611 and 612.

For example, the drive signal VOUT is supplied to one end of the piezoelectric element 60 and one of the electrode 611 and the electrode 612, and the reference voltage signal VBS is supplied to the other end of the piezoelectric element 60 and the other of the electrode 611 or the electrode 612. When the voltage value of the drive signal VOUT becomes low, the piezoelectric element 60 bends in the upward direction. In addition, the piezoelectric element 60 bends in the upward direction, whereby the vibrating plate 621 is displaced, and the internal volume of the cavity 631 is expanded. As a result, the ink is drawn from the reservoir 641. On the other hand, when the voltage value of the drive signal VOUT becomes high, the piezoelectric element 60 bends in the downward direction. In addition, the piezoelectric element 60 bends in the downward direction, whereby the vibrating plate 621 is displaced, and the internal volume of the cavity 631 is reduced. As a result, the ink is ejected from the nozzle 651 in an amount corresponding to the degree of reduction.

The structure of the piezoelectric element 60 is not limited to the example illustrated in FIG. 10, and may be a structure in which the ink can be ejected from the ejecting portion 600. Therefore, the structure of the piezoelectric element 60 is not limited to the above-described bending vibration structure, and may be, for example, a structure in which longitudinal vibration is used. In addition, the piezoelectric element 60 may be configured to bend in the downward direction when the voltage value of the drive signal VOUT becomes low and to bend in the upward direction when the voltage value of the drive signal VOUT becomes high.

That is, each of the print heads 21-1 to 21-4 included in the head unit 20 includes the piezoelectric element 60 including the electrode 611 and the electrode 612, and includes the ejecting portion 600 that ejects the liquid onto the medium by driving the piezoelectric element 60. In this case, for example, the drive signal VOUT corresponding to the drive signals COMA and COMB is supplied to the electrode 611, and the reference voltage signal VBS is supplied to the electrode 612. Then, the piezoelectric element 60 included in the ejecting portion 600 is driven in response to the potential difference between the drive signal VOUT and the reference voltage signal VBS, and the ejecting portion 600 ejects an amount of ink corresponding to the potential difference between the drive signal VOUT and the reference voltage signal VBS.

### 3.2. Structure of print head

Next, a structure of the print head 21 will be described. FIG. 11 is a view for explaining a structure of the print head 21. Here, in the following description, an X axis, a Y axis, and a Z axis, which are orthogonal to each other, will be used for the description. In addition, in the following description, in a case of specifying an orientation in a direction along the X axis, a start point side of an arrow along the X axis illustrated in the drawing may be referred to as a -X side and a tip side thereof may be referred to as a +X side; in a case of specifying an orientation in a direction along the Y axis, a start point side of an arrow along the Y axis illustrated in the drawing may be referred to as a -Y side and a tip side thereof may be referred to as a +Y side; and in a case of specifying an orientation in a direction along the Z axis, a start point side of an arrow along the Z axis illustrated in the drawing may be referred to as a -Z side and a tip side thereof may be referred to as a +Z side.

As illustrated in FIG. 11, the print head 21 includes a holder 23 and a cover member 24. In addition, the holder 23 has flanges 25 on both sides along the Y axis. A screw or the like (not illustrated) is inserted into the flange 25 and is fixed to a housing or the like of the liquid ejecting apparatus 1, so that the print head 21 is fixed. The cover member 24 is located on the -Z side of the holder 23. An opening 26 into which a connector 27 for supplying the various signals to the various circuits included in the print head 21 is inserted is formed at a side surface of the cover member 24 on the -Z side. Various configurations such as an ink flow passage (not illustrated) that introduces the ink supplied to the print head 21 into the ejecting portion 600 and the ejecting heads 22-1 to 22-4 that jet the ink are accommodated in a housing space configured by the holder 23 and the cover member 24.

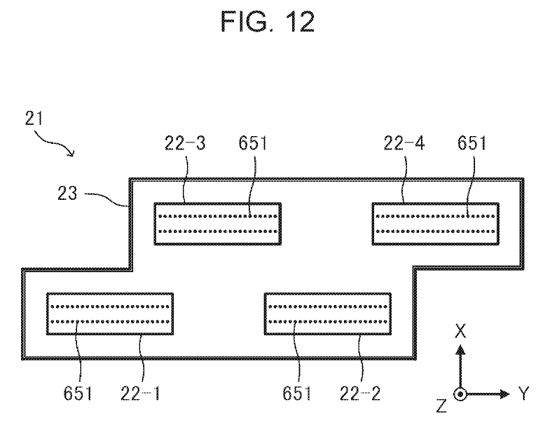

In this case, the ejecting heads 22-1 to 22-4 included in the print head 21 are held by the holder 23 such that the nozzles 651 included in the ejecting portions 600 included in the respective ejecting heads 22-1 to 22-4 are exposed from the surface of the print head 21 on the +Z side. FIG. 12 is a view illustrating the example of the structure of the print head 21 as viewed from the +Z side toward the -Z side along the Z axis. As illustrated in FIG. 12, in each of the ejecting heads 22-1 to 22-4, the nozzles 651 included in the respective ejecting portions 600 are arranged in two rows along the Y axis, so that two rows of nozzles are formed along the Y axis. The ejecting heads 22-1 to 22-4 are held by the holder 23 such that the two rows of nozzles formed along the Y axis are exposed from the surface of the holder 23 on the +Z side of the print head 21.

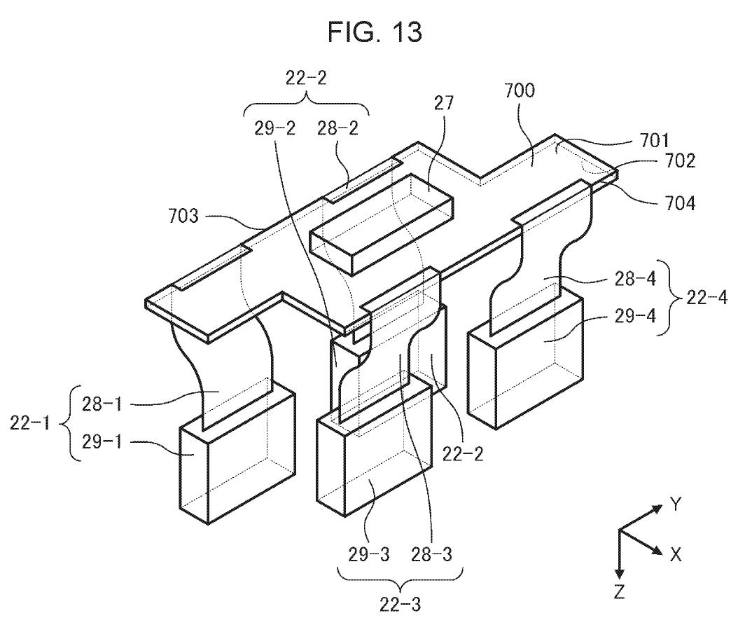

Next, an example of an internal structure of the print head 21 will be described. FIG. 13 is a view for explaining an example of an internal structure of the print head 21. As illustrated in FIG. 13, a wiring board 700 is accommodated in the housing space configured by the holder 23 and the cover member 24 included in the print head 21, in addition to the ejecting heads 22-1 to 22-4. In addition, an ink flow passage (not illustrated) or the like that introduces the ink into the ejecting portion 600 may be provided in the housing space configured by the holder 23 and the cover member 24 included in the print head 21.

The wiring board 700 includes surfaces 701 and 702 that are positioned to face each other, and edges 703 and 704 that are positioned to face each other. The wiring board 700 is accommodated inside the print head 21 such that the surfaces 701 and 702 extend along an XY plane formed by the X axis and the Y axis, the surface 701 is on the -Z side and the surface 702 is on the +Z side, and the edges 703 and 704 extend along the Y axis.

The connector 27 is mounted at substantially a central portion of the surface 701 of the wiring board 700. A flexible flat cable (FFC) (not illustrated) or the like is connected to the connector 27. The print head 21 and the control unit 10 are electrically connected to each other by the FFC, and various signals for controlling the print head 21 are supplied to the print head 21.

The ejecting heads 22-1 to 22-4 are positioned on the -Z side of the wiring board 700.

Each of the ejecting heads 22-1 to 22-4 includes flexible substrates 28-1 to 28-4 and heads 29-1 to 29-4. One end of each of the flexible substrates 28-1 and 28-2 is electrically connected to the surface 701 of the wiring board 700 in the vicinity of the edge 703 at the surface 701 of the wiring board 700, and one end of each of the flexible substrates 28-3 and 28-4 is electrically connected to the surface 701 of the wiring board 700 in the vicinity of the edge 704 at the surface 701 of the wiring board 700. The other ends of the flexible substrates 28-1 to 28-4 are electrically connected to the corresponding heads 29-1 to 29-4. That is, the wiring board 700 and each of the ejecting heads 22-1 to 22-4 are electrically connected to each other by the corresponding flexible substrates 28-1 to 28-4. In this case, the integrated circuit device constituting the temperature abnormality detection circuit 400 included in each of the ejecting heads 22-1 to 22-4 and the integrated circuit device constituting the drive signal selection circuit 200 are mounted on the corresponding flexible substrates 28-1 to 28-4 by chip on film (COF), and the plurality of ejecting portions 600 included in each of the ejecting heads 22-1 to 22-4 are included in the corresponding heads 29-1 to 29-4.

The various signals for controlling the print head 21, such as the printing data signals SI1 to SI4, the change signal CH, the latch signal LAT, the clock signal SCK, the drive signals COMA1 to COMA4 and COMB1 to COMB4, the reference voltage signals VBS1 to VBS4, and the voltage signals VHV, VDD1, and VDD2, are input to the print head 21 configured as described above through the connector 27. The above-described signals input to the print head 21 are propagated through the wiring board 700 and are input to the corresponding ejecting heads 22-1 to 22-4.

As described above, the print head 21 includes: the head 29-1 that ejects the ink by supplying the drive signal VOUT corresponding to the drive signals COMA1 and COMB1 in response to the printing data signal SI1, the change signal CH, the latch signal LAT, and the clock signal SCK; the head 29-2 that ejects the ink by supplying the drive signal VOUT corresponding to the drive signals COMA2 and COMB2 in response to the printing data signal SI2, the change signal CH, the latch signal LAT, and the clock signal SCK; the head 29-3 that ejects the ink by supplying the drive signal VOUT corresponding to the drive signals COMA3 and COMB3 in response to the printing data signal SI3, the change signal CH, the latch signal LAT, and the clock signal SCK; the head 29-4 that ejects the ink by supplying the drive signal VOUT corresponding to the drive signals COMA4 and COMB4 in response to the printing data signal SI4, the change signal CH, the latch signal LAT, and the clock signal SCK; the wiring board 700 that includes a wiring pattern through which the drive signals COMA1 to COMA4 and COMB1 to COMB4, the printing data signals SI1 to SI4, the change signal CH, the latch signal LAT, and the clock signal SCK are propagated; the flexible substrate 28-1 that has one end electrically connected to the wiring board 700 and the other end electrically connected to the head 29-1; the flexible substrate 28-2 that has one end electrically connected to the wiring board 700 and the other end electrically connected to the head 29-2; the flexible substrate 28-3 that has one end electrically connected to the wiring board 700 and the other end electrically connected to the head 29-3; and the flexible substrate 28-4 that has one end electrically connected to the wiring board 700 and the other end electrically connected to the head 29-4.

In this case, in the print head 21, the flexible substrate 28-1 is pulled out from the edge 703 side of the wiring board 700; the flexible substrate 28-2 is pulled out from the edge 703 side of the wiring board 700; the flexible substrate 28-3 is pulled out from the edge 704 side of the wiring board 700; and the flexible substrate 28-4 is pulled out from the edge 704 side of the wiring board 700. That is, the wiring board 700 includes the edge 703 from which the flexible substrates 28-1 and 28-2 are pulled out and the edge 704 that is positioned to face the edge 703 along the X axis and from which the flexible substrates 28-3 and 28-4 are pulled out.

### 3.3. Configuration of wiring board

Here, an example of a configuration of the wiring board 700 through which the various signals including the printing data signals SI1 to SI4, the change signal CH, the latch signal LAT, the clock signal SCK, the drive signals COMA1 to COMA4 and COMB1 to COMB4, the reference voltage signals VBS1 to VBS4, and the voltage signals VHV, VDD1, and VDD2 are propagated will be described.

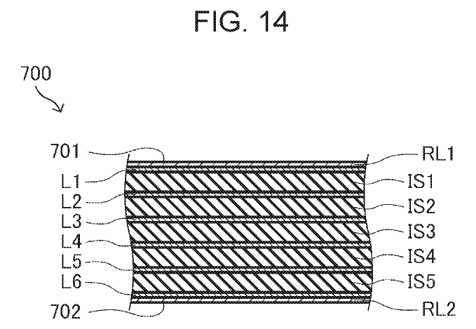

FIG. 14 is a view for explaining a schematic layer structure of the wiring board 700. As illustrated in FIG. 14, the wiring board 700 includes wiring layers L1 to L6, insulating layers IS1 to IS5, and resist layers RL1 and RL2.

The wiring layers L1 to L6 are stacked in the order of the wiring layer L1, the wiring layer L2, the wiring layer L3, the wiring layer L4, the wiring layer L5, and the wiring layer L6, along a stacking direction from the surface 701 to the surface 702 of the wiring board 700. In addition, along the stacking direction, the insulating layer IS1 is positioned between the wiring layer L1 and the wiring layer L2; the insulating layer IS2 is positioned between the wiring layer L2 and the wiring layer L3; the insulating layer IS3 is positioned between the wiring layer L3 and the wiring layer L4; the insulating layer IS4 is positioned between the wiring layer L4 and the wiring layer L5; and the insulating layer IS5 is positioned between the wiring layer L5 and the wiring layer L6. The resist layer RL1 is positioned on the surface 701 side opposite to the insulating layer IS1 in the wiring layer L1, and the resist layer RL2 is positioned on the surface 702 side opposite to the insulating layer IS5 in the wiring layer L6. That is, the wiring board 700 in the liquid ejecting apparatus 1 according to the present embodiment is a multilayer substrate in which the wiring layers L1 to L6 as a plurality of wiring layers, through which the printing data signals SI1 to SI4, the change signal CH, the latch signal LAT, the clock signal SCK, the drive signals COMA1 to COMA4 and COMB1 to COMB4, the reference voltage signals VBS1 to VBS4, and the voltage signals VHV, VDD1, and VDD2 propagate, are stacked. In other words, the wiring board 700 includes the wiring layer L1 positioned on the surface 701 side and the wiring layer L6 positioned on the surface 702 side, the insulating layer IS1 positioned between the wiring layer L1 and the wiring layer L6 along the stacking direction of the wiring board 700, the wiring layers L2 to L5 positioned between the insulating layer IS1 and the wiring layer L6, and the insulating layer IS5 positioned between the wiring layers L2 to L5 and the wiring layer L6. The number of layers included in the wiring board 700 is not limited to 6. In addition, the layer structure of the wiring board 700 will be described in detail later.

### 3.3.1. Configuration of wiring layer

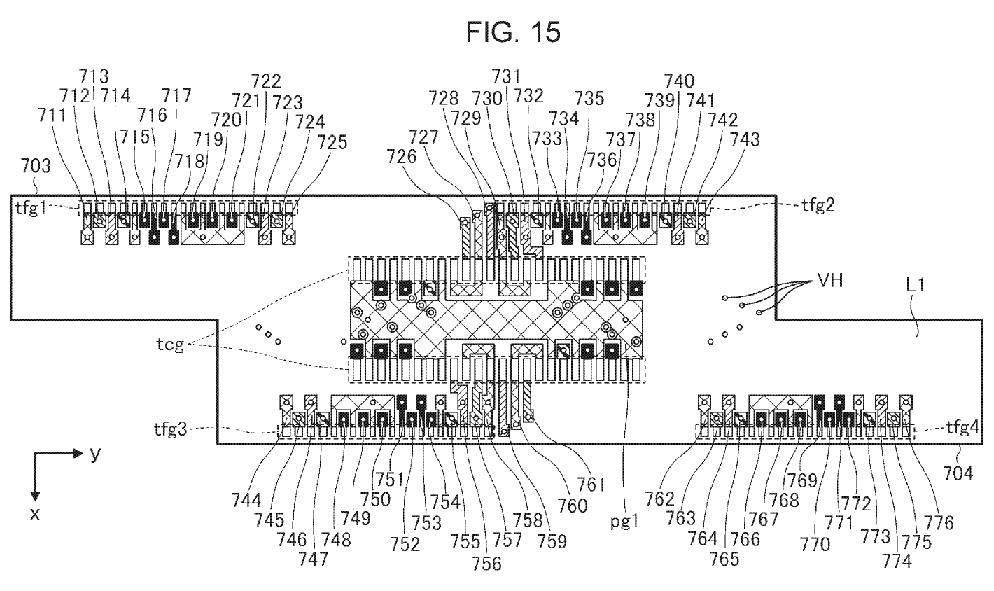

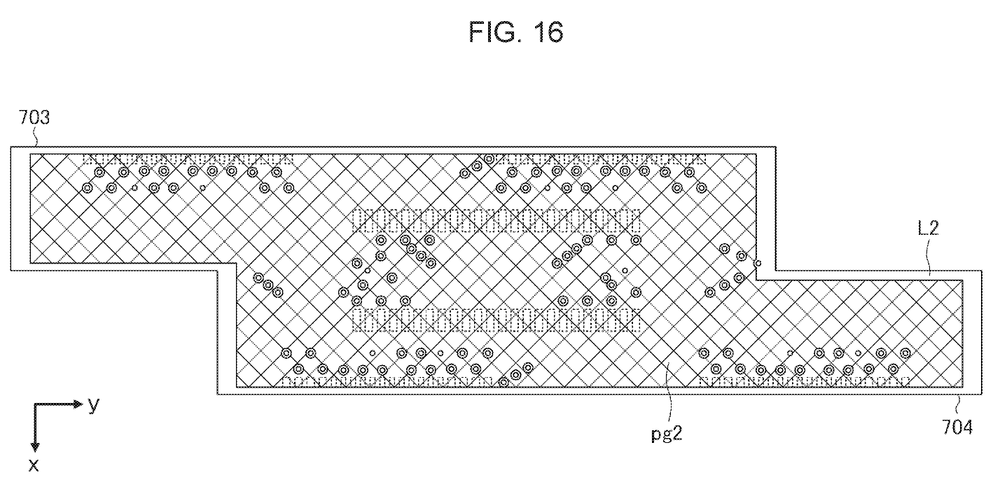

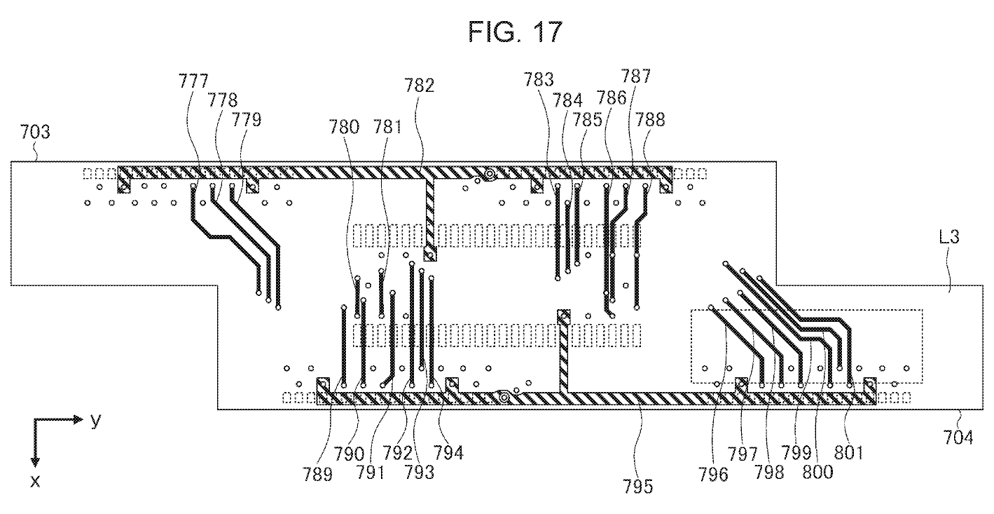

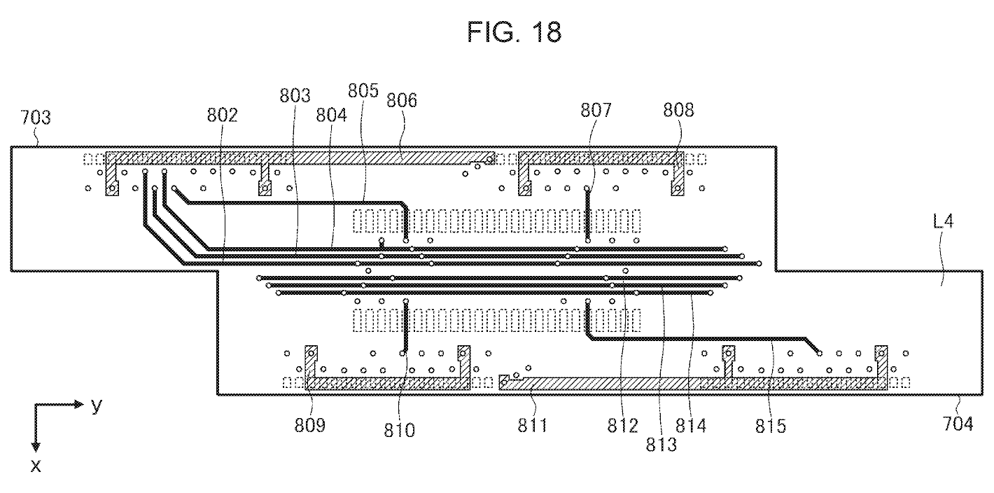

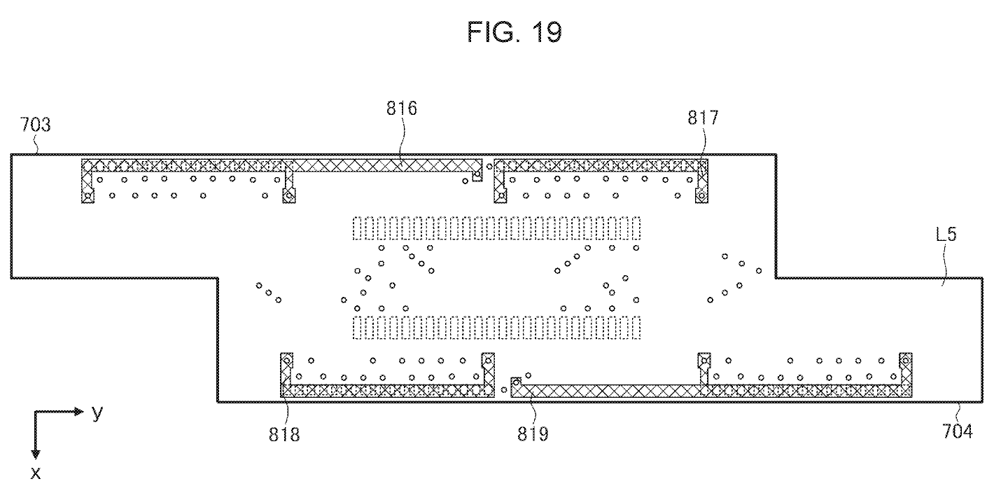

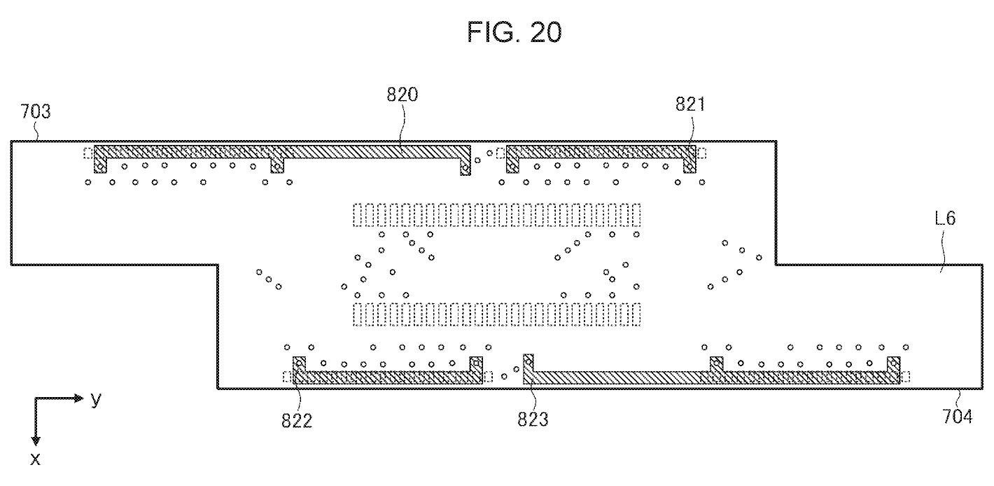

First, configurations of the wiring layers L1 to L6 included in the wiring board 700 will be described. FIG. 15 is a view illustrating an example of a configuration of the wiring layer L1 as viewed from the surface 701 along the stacking direction of the wiring board 700; FIG. 16 is a view illustrating an example of a configuration of the wiring layer L2 as viewed from the surface 701 along the stacking direction of the wiring board 700; FIG. 17 is a view illustrating an example of a configuration of the wiring layer L3 as viewed from the surface 701 along the stacking direction of the wiring board 700; FIG. 18 is a view illustrating an example of a configuration of the wiring layer L4 as viewed from the surface 701 along the stacking direction of the wiring board 700; FIG. 19 is a view illustrating an example of a configuration of the wiring layer L5 as viewed from the surface 701 along the stacking direction of the wiring board 700; and FIG. 20 is a view illustrating an example of a configuration of the wiring layer L6 as viewed from the surface 701 along the stacking direction of the wiring board 700.

Here, in FIGS. 15 to 20, a part other than the configuration formed in the corresponding wiring layers L1 to L6 may be illustrated by a broken line. In addition, in the following description, an x axis along the edges 703 and 704 of the wiring board 700 and a y axis orthogonal to the x axis are used. In the following description, in a case of specifying an orientation in a direction along the x axis, a start point side of an arrow along the x axis illustrated in the drawing may be referred to as a -x side and a tip side thereof may be referred to as a +x side; and in a case of specifying an orientation in a direction along the y axis, a start point side of an arrow along the y axis illustrated in the drawing may be referred to as a -y side and a tip side thereof may be referred to as a +y side. The x axis and the y axis may be axes extending in directions independent of the X axis, Y axis, and Z axis described above, but in the liquid ejecting apparatus 1 according to the present embodiment, the description will be made on the assumption that the wiring board 700 is provided such that the x axis extends along the above-described X axis, the y axis extends along the above-described Y axis, and the stacking direction is a direction along the above-described Z axis.

As illustrated in FIG. 15, electrode groups tcg and tfg1 to tfg4 are formed in the wiring layer L1.

The electrode group tcg includes a plurality of electrodes that are positioned at substantially a central portion of the surface 701 of the wiring board 700, and are arranged in two rows along the y axis. A plurality of terminals (not illustrated) included in the connector 27 are electrically connected to the plurality of electrodes included in the electrode group tcg. As a result, the connector 27 is electrically connected to the wiring board 700.

The electrode group tfg1 includes a plurality of electrodes that are positioned on the edge 703 side of the electrode group tcg and in the vicinity of the edge 703 of the surface 701 of the wiring board 700, and are arranged along the y axis. A plurality of terminals (not illustrated) formed at one end of the flexible substrate 28-1 are electrically connected to the plurality of electrodes included in the electrode group tfg1. As a result, the ejecting head 22-1 including the flexible substrate 28-1 is electrically connected to the wiring board 700.

The electrode group tfg2 includes a plurality of electrodes that are positioned on the edge 703 side of the electrode group tcg and in the vicinity of the edge 703 of the surface 701 of the wiring board 700, on the +y side of the electrode group tfg1, and are arranged along the y axis. A plurality of terminals (not illustrated) formed at one end of the flexible substrate 28-2 are electrically connected to the plurality of electrodes included in the electrode group tfg2. As a result, the ejecting head 22-2 including the flexible substrate 28-2 is electrically connected to the wiring board 700.

The electrode group tfg3 includes a plurality of electrodes that are positioned on the edge 704 side of the electrode group tcg and in the vicinity of the edge 704 of the surface 701 of the wiring board 700, and are arranged along the y axis. A plurality of terminals (not illustrated) formed at one end of the flexible substrate 28-3 are electrically connected to the plurality of electrodes included in the electrode group tfg3. As a result, the ejecting head 22-3 including the flexible substrate 28-3 is electrically connected to the wiring board 700.

The electrode group tfg4 includes a plurality of electrodes that are positioned on the edge 704 side of the electrode group tcg and in the vicinity of the edge 704 of the surface 701 of the wiring board 700, on the +y side of the electrode group tfg3, and are arranged along the y axis. A plurality of terminals (not illustrated) formed at one end of the flexible substrate 28-4 are electrically connected to the plurality of electrodes included in the electrode group tfg4. As a result, the ejecting head 22-4 including the flexible substrate 28-4 is electrically connected to the wiring board 700.

The plurality of electrodes included in each of the electrode groups tcg and tfg1 to tfg4 can be formed, for example, by removing a resist at a position corresponding to the plurality of electrodes included in each of the electrode groups tcg and tfg1 to tfg4, from a part of the resist constituting the resist layer RL1, to expose a charging portion formed in the wiring layer L1. That is, the electrode group tfg1 to which one end of the flexible substrate 28-1 is electrically connected, the electrode group tfg2 to which one end of the flexible substrate 28-2 is electrically connected, the electrode group tfg3 to which one end of the flexible substrate 28-3 is electrically connected, and the electrode group tfg4 to which one end of the flexible substrate 28-4 is electrically connected are provided in the wiring layer L1 among the wiring layers L1 to L6.

In addition, as illustrated in FIGS. 15 to 20, the wiring board 700 includes a plurality of wiring patterns formed in each of the wiring layers L1 to L6 and a plurality of vias VH that electrically connect the plurality of wiring patterns between the wiring layers L1 to L6. That is, the wiring board 700 includes a plurality of vias VH that penetrate the wiring layers L1 to L6 and the insulating layers IS1 to IS5. The plurality of wiring patterns and the plurality of vias VH formed in the wiring board 700 electrically connect each of the plurality of electrodes included in the electrode group tcg and each of the plurality of electrodes included in the electrode groups tfg1 to tfg4. As a result, a signal output from the control unit 10 is propagated through a cable such as the FFC, the connector 27, and the wiring board 700, and is input to the corresponding ejecting heads 22-1 to 22-4.

Here, the via VH in the liquid ejecting apparatus 1 according to the present embodiment will be described as a so-called through-hole via that penetrates from the surface 701 to the surface 702 of the wiring board 700 and electrically connects the plurality of wiring patterns between the wiring layers L1 to L6. The via VH may have any configuration as long as the via VH can electrically connect the wiring patterns between any layers of the wiring layers L1 to L6, and may be, for example, an interstitial via or a via having a configuration that is also used as a through-hole used for mounting a lead component. In addition, the configuration of the wiring board 700 illustrated in FIGS. 15 to 20 is an example, and the wiring board 700 may include a plurality of wiring patterns or vias other than the wiring patterns and the vias VH illustrated in FIGS. 15 to 20. In addition, the arrangement of the wiring patterns and the vias VH illustrated in FIGS. 15 to 20 is an example, and is not limited to the illustrated arrangement.

The drive signal COMA1 input to the connector 27 is propagated through a wiring 726 formed in the wiring layer L1, a wiring 820 formed in the wiring layer L6, a wiring 712 formed in the wiring layer L1, the via VH that electrically connects the wiring 726 and the wiring 820, and the via VH that electrically connects the wiring 820 and the wiring 712, and thus is supplied to the electrodes of the electrode group tfg1. In addition, the drive signal COMA1 input to the connector 27 is propagated through the wiring 726 formed in the wiring layer L1, the wiring 820 formed in the wiring layer L6, a wiring 724 formed in the wiring layer L1, the via VH that electrically connects the wiring 726 and the wiring 820, and the via VH that electrically connects the wiring 820 and the wiring 724, and thus is supplied to the electrodes of the electrode group tfg1. As a result, the drive signal COMA1 is input to the ejecting head 22-1.

The drive signal COMB1 input to the connector 27 is propagated through a wiring 728 formed in the wiring layer L1, a wiring 806 formed in the wiring layer L4, a wiring 713 formed in the wiring layer L1, the via VH that electrically connects the wiring 728 and the wiring 806, and the via VH that electrically connects the wiring 806 and the wiring 713, and thus is supplied to the electrodes of the electrode group tfg1. In addition, the drive signal COMB1 input to the connector 27 is propagated through the wiring 728 formed in the wiring layer L1, the wiring 806 formed in the wiring layer L4, a wiring 723 formed in the wiring layer L1, the via VH that electrically connects the wiring 728 and the wiring 806, and the via VH that electrically connects the wiring 806 and the wiring 723, and thus is supplied to the electrodes of the electrode group tfg1. As a result, the drive signal COMB1 is input to the ejecting head 22-1.

The reference voltage signal VBS1 input to the connector 27 is propagated through a wiring 727 formed in the wiring layer L1, a wiring 816 formed in the wiring layer L5, a wiring 711 formed in the wiring layer L1, the via VH that electrically connects the wiring 727 and the wiring 816, and the via VH that electrically connects the wiring 816 and the wiring 711, and thus is supplied to the electrodes of the electrode group tfg1. In addition, the reference voltage signal VBS1 input to the connector 27 is propagated through the wiring 727 formed in the wiring layer L1, the wiring 816 formed in the wiring layer L5, a wiring 725 formed in the wiring layer L1, the via VH that electrically connects the wiring 727 and the wiring 816, and the via VH that electrically connects the wiring 816 and the wiring 725, and thus is supplied to the electrodes of the electrode group tfg1. As a result, the reference voltage signal VBS1 is input to the ejecting head 22-1.

Here, the wiring 820 through which the drive signal COMA1 supplied to the ejecting head 22-1 is propagated, the wiring 806 through which the drive signal COMB1 supplied to the ejecting head 22-1 is propagated, and the wiring 816 through which the reference voltage signal VBS1 supplied to the ejecting head 22-1 is propagated extend along the edge 703 of the wiring board 700 on which the electrode group tfg1 to which the flexible substrate 28-1 included in the ejecting head 22-1 is electrically connected is positioned. In this case, as viewed from the surface 701 along the stacking direction of the wiring board 700, the wiring 820 is positioned such that at least a part thereof overlaps the electrode group tfg1, the wiring 806 is positioned such that at least a part thereof overlaps the electrode group tfg1, and the wiring 816 is positioned such that at least a part thereof overlaps the electrode group tfg1.

That is, each of the wiring 820 through which the drive signal COMA1 is propagated, the wiring 806 through which the drive signal COMB1 is propagated, and the wiring 816 through which the reference voltage signal VBS1 is propagated extends along the edge 703, and at least a part of the electrode group tfg1 to which one end of the flexible substrate 28-1 is electrically connected overlaps at least a part of each of the wiring 820 through which the drive signal COMA1 is propagated, the wiring 806 through which the drive signal COMB1 is propagated, and the wiring 816 through which the reference voltage signal VBS1 is propagated, as viewed from a normal direction of the wiring board 700 at the surface 701 in the stacking direction of the wiring board 700.

In the vicinity of the electrode group tfg1 to which the flexible substrate 28-1 included in the ejecting head 22-1 is electrically connected, the plurality of wiring patterns are densely arranged, and thus the region of the wiring board 700 overlapping the electrode group tfg1 is likely to be a dead space. On the other hand, in the liquid ejecting apparatus 1 according to the present embodiment, the wirings 820, 806, and 816 extend in the direction along the y axis in which the plurality of terminals included in the electrode group tfg1 are arranged and in the direction along the edge 703 of the wiring board 700, and are positioned such that at least a part thereof overlaps with the electrode group tfg1 as viewed from the surface 701 along the stacking direction of the wiring board 700. As a result, it is possible to effectively use the above-described dead space in the wiring board 700, and it is possible to achieve size reduction of the wiring board 700 and the print head 21 including the wiring board 700.

Furthermore, by positioning the wirings 820, 806, and 816 such that at least a part thereof overlaps the electrode group tfg1 as viewed from the surface 701 along the stacking direction of the wiring board 700, at least a part of the wiring 820 through which the drive signal COMA1 is propagated and at least a part of the wiring 806 through which the drive signal COMB1 is propagated overlap at least a part of the wiring 816 through which the reference voltage signal VBS1 is propagated, as viewed from the surface 701 along the stacking direction of the wiring board 700.

That is, the wiring 820 through which the drive signal COMA1 is propagated is provided in the wiring layer L6, the wiring 816 through which the reference voltage signal VBS1 is propagated is provided in the wiring layer L5 that is adjacent to the wiring layer L6 in the stacking direction of the wiring board 700, at least a part of the wiring 820 through which the drive signal COMA1 is propagated overlaps at least a part of the wiring 816 through which the reference voltage signal VBS1 is propagated as viewed from the stacking direction of the wiring board 700; and the wiring 806 through which the drive signal COMB1 is propagated is provided in the wiring layer L4, the wiring 816 through which the reference voltage signal VBS1 is propagated is provided in the wiring layer L5 that is adjacent to the wiring layer L4 in the stacking direction of the wiring board 700, and at least a part of the wiring 806 through which the drive signal COMB1 is propagated overlaps at least a part of the wiring 816 through which the reference voltage signal VBS1 is propagated as viewed from the stacking direction of the wiring board 700.

Currents flowing through the wirings 820 and 806 in response to the propagation of the drive signals COMA1 and COMB1 are supplied to the piezoelectric element 60 included in the ejecting head 22-1, and then flow through the wiring 816 through which the reference voltage signal VBS1 is propagated and return to the drive circuit 50-1. Therefore, in the wirings 820 and 806 through which the drive signals COMA1 and COMB1 are propagated and the wiring 816 through which the reference voltage signal VBS1 is propagated, the currents flow in opposite directions. In this case, the wirings 820, 806, and 816 are positioned such that, as viewed from the surface 701 along the stacking direction of the wiring board 700, at least a part of the wiring 820 through which the drive signal COMA1 is propagated overlaps with at least a part of the wiring 816 through which the reference voltage signal VBS1 is propagated and at least a part of the wiring 806 through which the drive signal COMB1 is propagated overlaps with at least a part of the wiring 816 through which the reference voltage signal VBS1 is propagated, so that a magnetic field generated by the currents flowing through the wirings 820 and 806 and a magnetic field generated by the current flowing through the wiring 816 are efficiently canceled out. As a result, an impedance of the wirings 820, 806, and 816 is less likely to change due to the magnetic field generated by the currents flowing through the wirings 820, 806, and 816. Therefore, the influence of the impedance on the drive signal COMA1 that is propagated through the wiring 820, the drive signal COMB1 that is propagated through the wiring 806, and the reference voltage signal VBS1 that is propagated through the wiring 816 may be reduced. Accordingly, the waveform accuracy of the drive signals COMA1 and COMB1 and the reference voltage signal VBS1, input to the ejecting head 22-1, is improved.

The drive signal COMA2 input to the connector 27 is propagated through a wiring 730 formed in the wiring layer L1 and is supplied to the electrodes of the electrode group tfg2. In addition, the drive signal COMA2 input to the connector 27 is propagated through the wiring 730 formed in the wiring layer L1, a wiring 821 formed in the wiring layer L6, a wiring 742 formed in the wiring layer L1, the via VH that electrically connects the wiring 730 and the wiring 821, and the via VH that electrically connects the wiring 821 and the wiring 742, and thus is supplied to the electrodes of the electrode group tfg2. As a result, the drive signal COMA2 is input to the ejecting head 22-2.

The drive signal COMB2 input to the connector 27 is propagated through a wiring 731 formed in the wiring layer L1 and is supplied to the electrodes of the electrode group tfg2. In addition, the drive signal COMB2 input to the connector 27 is propagated through the wiring 731 formed in the wiring layer L1, a wiring 808 formed in the wiring layer L4, a wiring 741 formed in the wiring layer L1, the via VH that electrically connects the wiring 731 and the wiring 808, and the via VH that electrically connects the wiring 808 and the wiring 741, and thus is supplied to the electrodes of the electrode group tfg2. As a result, the drive signal COMB2 is input to the ejecting head 22-2.

The reference voltage signal VBS2 input to the connector 27 is propagated through a wiring 729 formed in the wiring layer L1 and is supplied to the electrodes of the electrode group tfg2. In addition, the reference voltage signal VBS2 input to the connector 27 is propagated through the wiring 729 formed in the wiring layer L1, a wiring 817 formed in the wiring layer L5, a wiring 743 formed in the wiring layer L1, the via VH that electrically connects the wiring 729 and the wiring 817, and the via VH that electrically connects the wiring 817 and the wiring 743, and thus is supplied to the electrodes of the electrode group tfg2. As a result, the reference voltage signal VBS2 is input to the ejecting head 22-2.

Here, the wiring 821 through which the drive signal COMA2 supplied to the ejecting head 22-2 is propagated, the wiring 808 through which the drive signal COMB2 supplied to the ejecting head 22-2 is propagated, and the wiring 817 through which the reference voltage signal VBS2 supplied to the ejecting head 22-2 is propagated extend along the edge 703 of the wiring board 700 on which the electrode group tfg2 to which the flexible substrate 28-2 included in the ejecting head 22-2 is electrically connected is positioned. In this case, as viewed from the surface 701 along the stacking direction of the wiring board 700, the wiring 821 is positioned such that at least a part thereof overlaps the electrode group tfg2, the wiring 808 is positioned such that at least a part thereof overlaps the electrode group tfg2, and the wiring 817 is positioned such that at least a part thereof overlaps the electrode group tfg2.

That is, each of the wiring 821 through which the drive signal COMA2 is propagated, the wiring 808 through which the drive signal COMB2 is propagated, and the wiring 817 through which the reference voltage signal VBS2 is propagated extends along the edge 703, and at least a part of the electrode group tfg2 to which one end of the flexible substrate 28-2 is electrically connected overlaps at least a part of each of the wiring 821 through which the drive signal COMA2 is propagated, the wiring 808 through which the drive signal COMB2 is propagated, and the wiring 817 through which the reference voltage signal VBS2 is propagated, as viewed from a normal direction of the wiring board 700 at the surface 701 in the stacking direction of the wiring board 700.

In the vicinity of the electrode group tfg2 to which the flexible substrate 28-2 included in the ejecting head 22-2 is electrically connected, the plurality of wiring patterns are densely arranged, and thus the region of the wiring board 700 overlapping the electrode group tfg2 is likely to be a dead space. On the other hand, in the liquid ejecting apparatus 1 according to the present embodiment, the wirings 821, 808, and 817 extend in the direction along the y axis in which the plurality of terminals included in the electrode group tfg2 are arranged and in the direction along the edge 703 of the wiring board 700, and are positioned such that at least a part thereof overlaps with the electrode group tfg2 as viewed from the surface 701 along the stacking direction of the wiring board 700. As a result, it is possible to effectively use the above-described dead space in the wiring board 700, and it is possible to achieve size reduction of the wiring board 700 and the print head 21 including the wiring board 700.

Furthermore, by positioning the wirings 821, 808, and 817 such that at least a part thereof overlaps the electrode group tfg2 as viewed from the surface 701 along the stacking direction of the wiring board 700, at least a part of the wiring 821 through which the drive signal COMA2 is propagated and at least a part of the wiring 808 through which the drive signal COMB2 is propagated overlap at least a part of the wiring 817 through which the reference voltage signal VBS2 is propagated, as viewed from the surface 701 along the stacking direction of the wiring board 700.

That is, the wiring 821 through which the drive signal COMA2 is propagated is provided in the wiring layer L6, the wiring 817 through which the reference voltage signal VBS2 is propagated is provided in the wiring layer L5 that is adjacent to the wiring layer L6 in the stacking direction of the wiring board 700, at least a part of the wiring 821 through which the drive signal COMA2 is propagated overlaps at least a part of the wiring 817 through which the reference voltage signal VBS2 is propagated as viewed from the stacking direction of the wiring board 700; and the wiring 808 through which the drive signal COMB2 is propagated is provided in the wiring layer L4, the wiring 817 through which the reference voltage signal VBS2 is propagated is provided in the wiring layer L5 that is adjacent to the wiring layer L4 in the stacking direction of the wiring board 700, and at least a part of the wiring 808 through which the drive signal COMB2 is propagated overlaps at least a part of the wiring 817 through which the reference voltage signal VBS2 is propagated as viewed from the stacking direction of the wiring board 700.

Currents flowing through the wirings 821 and 808 in response to the propagation of the drive signals COMA2 and COMB2 are supplied to the piezoelectric element 60 included in the ejecting head 22-2, and then flow through the wiring 817 through which the reference voltage signal VBS2 is propagated and return to the drive circuit 50-2. Therefore, in the wirings 821 and 808 through which the drive signals COMA2 and COMB2 are propagated and the wiring 817 through which the reference voltage signal VBS2 is propagated, the currents flow in opposite directions. In this case, the wirings 821, 808, and 817 are positioned such that, as viewed from the surface 701 along the stacking direction of the wiring board 700, at least a part of the wiring 821 through which the drive signal COMA2 is propagated overlaps with at least a part of the wiring 817 through which the reference voltage signal VBS2 is propagated and at least a part of the wiring 808 through which the drive signal COMB2 is propagated overlaps with at least a part of the wiring 817 through which the reference voltage signal VBS2 is propagated, so that a magnetic field generated by the currents flowing through the wirings 821 and 808 and a magnetic field generated by the current flowing through the wiring 817 are efficiently canceled out. As a result, an impedance of the wirings 821, 808, and 817 is less likely to change due to the magnetic field generated by the currents flowing through the wirings 821, 808, and 817. Therefore, the influence of the impedance on the drive signal COMA2 that is propagated through the wiring 821, the drive signal COMB2 that is propagated through the wiring 808, and the reference voltage signal VBS2 that is propagated through the wiring 817 is reduced. Accordingly, the waveform accuracy of the drive signals COMA2 and COMB2 and the reference voltage signal VBS2, input to the ejecting head 22-2, is improved.

The drive signal COMA3 input to the connector 27 is propagated through a wiring 757 formed in the wiring layer L1 and is supplied to the electrodes of the electrode group tfg3. In addition, the drive signal COMA3 input to the connector 27 is propagated through the wiring 757 formed in the wiring layer L1, a wiring 822 formed in the wiring layer L6, a wiring 745 formed in the wiring layer L1, the via VH that electrically connects the wiring 757 and the wiring 822, and the via VH that electrically connects the wiring 822 and the wiring 745, and thus is supplied to the electrodes of the electrode group tfg3. As a result, the drive signal COMA3 is input to the ejecting head 22-3.

The drive signal COMB3 input to the connector 27 is propagated through a wiring 756 formed in the wiring layer L1 and is supplied to the electrodes of the electrode group tfg3. In addition, the drive signal COMB3 input to the connector 27 is propagated through the wiring 756 formed in the wiring layer L1, a wiring 809 formed in the wiring layer L4, a wiring 746 formed in the wiring layer L1, the via VH that electrically connects the wiring 756 and the wiring 809, and the via VH that electrically connects the wiring 809 and the wiring 746, and thus is supplied to the electrodes of the electrode group tfg3. As a result, the drive signal COMB3 is input to the ejecting head 22-3.

The reference voltage signal VBS3 input to the connector 27 is propagated through a wiring 758 formed in the wiring layer L1 and is supplied to the electrodes of the electrode group tfg3. In addition, the reference voltage signal VBS3 input to the connector 27 is propagated through the wiring 758 formed in the wiring layer L1, a wiring 818 formed in the wiring layer L5, a wiring 744 formed in the wiring layer L1, the via VH that electrically connects the wiring 758 and the wiring 818, and the via VH that electrically connects the wiring 818 and the wiring 744, and thus is supplied to the electrodes of the electrode group tfg3. As a result, the reference voltage signal VBS3 is input to the ejecting head 22-3.

Here, the wiring 822 through which the drive signal COMA3 supplied to the ejecting head 22-3 is propagated, the wiring 809 through which the drive signal COMB3 supplied to the ejecting head 22-3 is propagated, and the wiring 818 through which the reference voltage signal VBS3 supplied to the ejecting head 22-3 is propagated extend along the edge 704 of the wiring board 700 on which the electrode group tfg3 to which the flexible substrate 28-3 included in the ejecting head 22-3 is electrically connected is positioned. In this case, as viewed from the surface 701 along the stacking direction of the wiring board 700, the wiring 822 is positioned such that at least a part thereof overlaps the electrode group tfg3, the wiring 809 is positioned such that at least a part thereof overlaps the electrode group tfg3, and the wiring 818 is positioned such that at least a part thereof overlaps the electrode group tfg3.

That is, each of the wiring 822 through which the drive signal COMA3 is propagated, the wiring 809 through which the drive signal COMB3 is propagated, and the wiring 818 through which the reference voltage signal VBS3 is propagated extends along the edge 704, and at least a part of the electrode group tfg3 to which one end of the flexible substrate 28-3 is electrically connected overlaps at least a part of each of the wiring 822 through which the drive signal COMA3 is propagated, the wiring 809 through which the drive signal COMB3 is propagated, and the wiring 818 through which the reference voltage signal VBS3 is propagated, as viewed from a normal direction of the wiring board 700 at the surface 701 in the stacking direction of the wiring board 700.

In the vicinity of the electrode group tfg3 to which the flexible substrate 28-3 included in the ejecting head 22-3 is electrically connected, the plurality of wiring patterns are densely arranged, and thus the region of the wiring board 700 overlapping the electrode group tfg3 is likely to be a dead space. On the other hand, in the liquid ejecting apparatus 1 according to the present embodiment, the wirings 822, 809, and 818 extend in the direction along the y axis in which the plurality of terminals included in the electrode group tfg3 are arranged and in the direction along the edge 704 of the wiring board 700, and are positioned such that at least a part thereof overlaps with the electrode group tfg3 as viewed from the surface 701 along the stacking direction of the wiring board 700. As a result, it is possible to effectively use the above-described dead space in the wiring board 700, and it is possible to achieve size reduction of the wiring board 700 and the print head 21 including the wiring board 700.

Furthermore, by positioning the wirings 822, 809, and 818 such that at least a part thereof overlaps the electrode group tfg3 as viewed from the surface 701 along the stacking direction of the wiring board 700, at least a part of the wiring 822 through which the drive signal COMA3 is propagated and at least a part of the wiring 809 through which the drive signal COMB3 is propagated overlap at least a part of the wiring 818 through which the reference voltage signal VBS3 is propagated, as viewed from the surface 701 along the stacking direction of the wiring board 700.

That is, the wiring 822 through which the drive signal COMA3 is propagated is provided in the wiring layer L6, the wiring 818 through which the reference voltage signal VBS3 is propagated is provided in the wiring layer L5 that is adjacent to the wiring layer L6 in the stacking direction of the wiring board 700, at least a part of the wiring 822 through which the drive signal COMA3 is propagated overlaps at least a part of the wiring 818 through which the reference voltage signal VBS3 is propagated as viewed from the stacking direction of the wiring board 700; and the wiring 809 through which the drive signal COMB3 is propagated is provided in the wiring layer L4, the wiring 818 through which the reference voltage signal VBS3 is propagated is provided in the wiring layer L5 that is adjacent to the wiring layer L4 in the stacking direction of the wiring board 700, and at least a part of the wiring 809 through which the drive signal COMB3 is propagated overlaps at least a part of the wiring 818 through which the reference voltage signal VBS3 is propagated as viewed from the stacking direction of the wiring board 700.

Currents flowing through the wirings 822 and 809 in response to the propagation of the drive signals COMA3 and COMB3 are supplied to the piezoelectric element 60 included in the ejecting head 22-3, and then flow through the wiring 818 through which the reference voltage signal VBS3 is propagated and return to the drive circuit 50-3. Therefore, in the wirings 822 and 809 through which the drive signals COMA3 and COMB3 are propagated and the wiring 818 through which the reference voltage signal VBS3 is propagated, the currents flow in opposite directions. In this case, the wirings 822, 809, and 818 are positioned such that, as viewed from the surface 701 along the stacking direction of the wiring board 700, at least a part of the wiring 822 through which the drive signal COMA3 is propagated overlaps with at least a part of the wiring 818 through which the reference voltage signal VBS3 is propagated and at least a part of the wiring 809 through which the drive signal COMB3 is propagated overlaps with at least a part of the wiring 818 through which the reference voltage signal VBS3 is propagated, so that a magnetic field generated by the currents flowing through the wirings 822 and 809 and a magnetic field generated by the current flowing through the wiring 818 are efficiently canceled out. As a result, an impedance of the wirings 822, 809, and 818 is less likely to change due to the magnetic field generated by the currents flowing through the wirings 822, 809, and 818. Therefore, the influence of the impedance on the drive signal COMA3 that is propagated through the wiring 822, the drive signal COMB3 that is propagated through the wiring 809, and the reference voltage signal VBS3 that is propagated through the wiring 818 is reduced. Accordingly, the waveform accuracy of the drive signals COMA3 and COMB3 and the reference voltage signal VBS3, input to the ejecting head 22-3, is improved.

The drive signal COMA4 input to the connector 27 is propagated through a wiring 761 formed in the wiring layer L1, a wiring 823 formed in the wiring layer L6, a wiring 763 formed in the wiring layer L1, the via VH that electrically connects the wiring 761 and the wiring 823, and the via VH that electrically connects the wiring 823 and the wiring 763, and thus is supplied to the electrodes of the electrode group tfg4. In addition, the drive signal COMA4 input to the connector 27 is propagated through the wiring 761 formed in the wiring layer L1, the wiring 823 formed in the wiring layer L6, a wiring 775 formed in the wiring layer L1, the via VH that electrically connects the wiring 761 and the wiring 823, and the via VH that electrically connects the wiring 823 and the wiring 775, and thus is supplied to the electrodes of the electrode group tfg4. As a result, the drive signal COMA4 is input to the ejecting head 22-4.

The drive signal COMB4 input to the connector 27 is propagated through a wiring 759 formed in the wiring layer L1, a wiring 811 formed in the wiring layer L4, a wiring 764 formed in the wiring layer L1, the via VH that electrically connects the wiring 759 and the wiring 811, and the via VH that electrically connects the wiring 811 and the wiring 764, and thus is supplied to the electrodes of the electrode group tfg4. In addition, the drive signal COMB4 input to the connector 27 is propagated through the wiring 759 formed in the wiring layer L1, the wiring 811 formed in the wiring layer L4, a wiring 774 formed in the wiring layer L1, the via VH that electrically connects the wiring 759 and the wiring 811, and the via VH that electrically connects the wiring 811 and the wiring 774, and thus is supplied to the electrodes of the electrode group tfg4. As a result, the drive signal COMB4 is input to the ejecting head 22-4.

The reference voltage signal VBS4 input to the connector 27 is propagated through a wiring 760 formed in the wiring layer L1, a wiring 819 formed in the wiring layer L5, a wiring 762 formed in the wiring layer L1, the via VH that electrically connects the wiring 760 and the wiring 819, and the via VH that electrically connects the wiring 819 and the wiring 762, and thus is supplied to the electrodes of the electrode group tfg4. In addition, the reference voltage signal VBS4 input to the connector 27 is propagated through the wiring 760 formed in the wiring layer L1, the wiring 819 formed in the wiring layer L5, a wiring 776 formed in the wiring layer L1, the via VH that electrically connects the wiring 760 and the wiring 819, and the via VH that electrically connects the wiring 819 and the wiring 776, and thus is supplied to the electrodes of the electrode group tfg4. As a result, the reference voltage signal VBS4 is input to the ejecting head 22-4.

Here, the wiring 823 through which the drive signal COMA4 supplied to the ejecting head 22-4 is propagated, the wiring 811 through which the drive signal COMB4 supplied to the ejecting head 22-4 is propagated, and the wiring 819 through which the reference voltage signal VBS4 supplied to the ejecting head 22-4 is propagated extend along the edge 704 of the wiring board 700 on which the electrode group tfg4 to which the flexible substrate 28-4 included in the ejecting head 22-4 is electrically connected is positioned. In this case, as viewed from the surface 701 along the stacking direction of the wiring board 700, the wiring 823 is positioned such that at least a part thereof overlaps the electrode group tfg4, the wiring 811 is positioned such that at least a part thereof overlaps the electrode group tfg4, and the wiring 819 is positioned such that at least a part thereof overlaps the electrode group tfg4.

That is, each of the wiring 823 through which the drive signal COMA4 is propagated, the wiring 811 through which the drive signal COMB4 is propagated, and the wiring 819 through which the reference voltage signal VBS4 is propagated extends along the edge 704, and at least a part of the electrode group tfg4 to which one end of the flexible substrate 28-4 is electrically connected overlaps at least a part of each of the wiring 823 through which the drive signal COMA4 is propagated, the wiring 811 through which the drive signal COMB4 is propagated, and the wiring 819 through which the reference voltage signal VBS4 is propagated, as viewed from a normal direction of the wiring board 700 at the surface 701 in the stacking direction of the wiring board 700.

In the vicinity of the electrode group tfg4 to which the flexible substrate 28-4 included in the ejecting head 22-4 is electrically connected, the plurality of wiring patterns are densely arranged, and thus the region of the wiring board 700 overlapping the electrode group tfg4 is likely to be a dead space. On the other hand, in the liquid ejecting apparatus 1 according to the present embodiment, the wirings 823, 811, and 819 extend in the direction along the y axis in which the plurality of terminals included in the electrode group tfg4 are arranged and in the direction along the edge 704 of the wiring board 700, and are positioned such that at least a part thereof overlaps with the electrode group tfg4 as viewed from the surface 701 along the stacking direction of the wiring board 700. As a result, it is possible to effectively use the above-described dead space in the wiring board 700, and it is possible to achieve size reduction of the wiring board 700 and the print head 21 including the wiring board 700.

Furthermore, by positioning the wirings 823, 811, and 819 such that at least a part thereof overlaps the electrode group tfg4 as viewed from the surface 701 along the stacking direction of the wiring board 700, at least a part of the wiring 823 through which the drive signal COMA4 is propagated and at least a part of the wiring 811 through which the drive signal COMB4 is propagated overlap at least a part of the wiring 819 through which the reference voltage signal VBS4 is propagated, as viewed from the surface 701 along the stacking direction of the wiring board 700.

That is, the wiring 823 through which the drive signal COMA4 is propagated is provided in the wiring layer L6, the wiring 819 through which the reference voltage signal VBS4 is propagated is provided in the wiring layer L5 that is adjacent to the wiring layer L6 in the stacking direction of the wiring board 700, at least a part of the wiring 823 through which the drive signal COMA4 is propagated overlaps at least a part of the wiring 819 through which the reference voltage signal VBS4 is propagated as viewed from the stacking direction of the wiring board 700; and the wiring 811 through which the drive signal COMB4 is propagated is provided in the wiring layer L4, the wiring 819 through which the reference voltage signal VBS4 is propagated is provided in the wiring layer L5 that is adjacent to the wiring layer L4 in the stacking direction of the wiring board 700, and at least a part of the wiring 811 through which the drive signal COMB4 is propagated overlaps at least a part of the wiring 819 through which the reference voltage signal VBS4 is propagated as viewed from the stacking direction of the wiring board 700.

Currents flowing through the wirings 823 and 811 in response to the propagation of the drive signals COMA4 and COMB4 are supplied to the piezoelectric element 60 included in the ejecting head 22-4, and then flow through the wiring 819 through which the reference voltage signal VBS4 is propagated and return to the drive circuit 50-4. Therefore, in the wirings 823 and 811 through which the drive signals COMA4 and COMB4 are propagated and the wiring 819 through which the reference voltage signal VBS4 is propagated, the currents flow in opposite directions. In this case, the wirings 823, 811, and 819 are positioned such that, as viewed from the surface 701 along the stacking direction of the wiring board 700, at least a part of the wiring 823 through which the drive signal COMA4 is propagated overlaps with at least a part of the wiring 819 through which the reference voltage signal VBS4 is propagated and at least a part of the wiring 811 through which the drive signal COMB4 is propagated overlaps with at least a part of the wiring 819 through which the reference voltage signal VBS4 is propagated, so that a magnetic field generated by the currents flowing through the wirings 823 and 811 and a magnetic field generated by the current flowing through the wiring 819 are efficiently canceled out. As a result, an impedance of the wirings 823, 811, and 819 is less likely to change due to the magnetic field generated by the currents flowing through the wirings 823, 811, and 819. Therefore, the influence of the impedance on the drive signal COMA4 that is propagated through the wiring 823, the drive signal COMB4 that is propagated through the wiring 811, and the reference voltage signal VBS4 that is propagated through the wiring 819 is reduced. Accordingly, the waveform accuracy of the drive signals COMA4 and COMB4 and the reference voltage signal VBS4, input to the ejecting head 22-4, is improved.

In addition, voltage signals VHV1 and VHV2 as the voltage signal VHV are input to the connector 27. The voltage signals VHV1 and VHV2 are signals branched from the voltage signal VHV, and are signals having substantially the same voltage value. In the connector 27, the voltage signal VHV may be input to any of the electrodes included in the electrode group tcg without being branched.

The voltage signal VHV1 input to the connector 27 is propagated through a wiring pattern formed in the wiring layer L1, and then is supplied to a wiring 782 formed in the wiring layer L3 through the via VH. The voltage signal VHV1 supplied to the wiring 782 is propagated through the wiring 782 formed in the wiring layer L3 and a wiring 714 formed in the wiring layer L1 and the via VH that electrically connects the wiring 782 and the wiring 714, and is supplied to the electrodes included in the electrode group tfg1; and is propagated through the wiring 782 formed in the wiring layer L3 and a wiring 722 formed in the wiring layer L1 and the via VH that electrically connects the wiring 782 and the wiring 722, and is supplied to the electrodes included in the electrode group tfg1. In addition, the voltage signal VHV1 supplied to the wiring 782 is propagated through the wiring 782 formed in the wiring layer L3 and a wiring 732 formed in the wiring layer L1 and the via VH that electrically connects the wiring 782 and the wiring 732, and is supplied to the electrodes included in the electrode group tfg2; and is propagated through the wiring 782 formed in the wiring layer L3 and a wiring 740 formed in the wiring layer L1 and the via VH that electrically connects the wiring 782 and the wiring 740, and is supplied to the electrodes included in the electrode group tfg2. As a result, the voltage signal VHV1 as the voltage signal VHV is input to the ejecting heads 22-1 and 22-2.

The voltage signal VHV2 input to the connector 27 is propagated through the wiring pattern formed in the wiring layer L1, and then is supplied to a wiring 795 formed in the wiring layer L3 through the via VH. The voltage signal VHV2 supplied to the wiring 795 is propagated through the wiring 795 formed in the wiring layer L3 and a wiring 747 formed in the wiring layer L1 and the via VH that electrically connects the wiring 795 and the wiring 747, and is supplied to the electrodes included in the electrode group tfg3; and is propagated through the wiring 795 formed in the wiring layer L3 and a wiring 755 formed in the wiring layer L1 and the via VH that electrically connects the wiring 795 and the wiring 755, and is supplied to the electrodes included in the electrode group tfg3. In addition, the voltage signal VHV2 supplied to the wiring 795 is propagated through the wiring 795 formed in the wiring layer L3 and a wiring 765 formed in the wiring layer L1 and the via VH that electrically connects the wiring 795 and the wiring 765, and is supplied to the electrodes included in the electrode group tfg4; and is propagated through the wiring 795 formed in the wiring layer L3 and a wiring 773 formed in the wiring layer L1 and the via VH that electrically connects the wiring 795 and the wiring 773, and is supplied to the electrodes included in the electrode group tfg4. As a result, the voltage signal VHV2 as the voltage signal VHV is input to the ejecting heads 22-3 and 22-4.

Here, the wiring 782 through which the voltage signal VHV1 supplied to the ejecting heads 22-1 and 22-2 is propagated extends along the edge 703 of the wiring board 700 on which the electrode group tfg1 to which the flexible substrate 28-1 included in the ejecting head 22-1 is electrically connected and the electrode group tfg2 to which the flexible substrate 28-2 included in the ejecting head 22-2 is electrically connected are positioned. In this case, as viewed from the surface 701 along the stacking direction of the wiring board 700, the wiring 782 is positioned such that a part thereof overlaps with the electrode group tfg1 and a different part thereof overlaps with the electrode group tfg2. As a result, it is possible to effectively use a region near the electrode groups tfg1 and tfg2 that is likely to be the dead space in the wiring board 700, and it is possible to achieve size reduction of the wiring board 700 and the print head 21 including the wiring board 700.

In addition, the wiring 795 through which the voltage signal VHV2 supplied to the ejecting heads 22-3 and 22-4 is propagated extends along the edge 704 of the wiring board 700 on which the electrode group tfg3 to which the flexible substrate 28-3 included in the ejecting head 22-3 is electrically connected and the electrode group tfg4 to which the flexible substrate 28-4 included in the ejecting head 22-4 is electrically connected are positioned. In this case, as viewed from the surface 701 along the stacking direction of the wiring board 700, the wiring 795 is positioned such that a part thereof overlaps with the electrode group tfg3 and a different part thereof overlaps with the electrode group tfg4. As a result, it is possible to effectively use a region near the electrode groups tfg3 and tfg4 that is likely to be the dead space in the wiring board 700, and it is possible to achieve size reduction of the wiring board 700 and the print head 21 including the wiring board 700.

That is, the wiring board 700 includes the wirings 782 and 795 through which the voltage signals VHV1 and VHV2 as the voltage signal VHV used for generating the drive signals COMA1 to COMA4 and COMB1 to COMB4 are propagated, and at least a part of the wiring 782 is positioned to overlap at least a part of the electrode group tfg1 and at least a part of the electrode group tfg2, and at least a part of the wiring 795 is positioned to overlap at least a part of the electrode group tfg3 and at least a part of the electrode group tfg4, as viewed from the stacking direction of the wiring board 700. Therefore, as viewed from the stacking direction of the wiring board 700, at least a part of the wiring 820 through which the drive signal COMA1 is propagated, the wiring 806 through which the drive signal COMB1 is propagated, and the wiring 816 through which the reference voltage signal VBS1 is propagated, and at least a part of the wiring 821 through which the drive signal COMA2 is propagated, the wiring 808 through which the drive signal COMB2 is propagated, and the wiring 817 through which the reference voltage signal VBS2 is propagated overlap at least a part of the wiring 782 through which the voltage signal VHV1 is propagated; and at least a part of the wiring 822 through which the drive signal COMA3 is propagated, the wiring 809 through which the drive signal COMB3 is propagated, and the wiring 818 through which the reference voltage signal VBS3 is propagated, and at least a part of the wiring 823 through which the drive signal COMA4 is propagated, the wiring 811 through which the drive signal COMB4 is propagated, and the wiring 819 through which the reference voltage signal VBS4 is propagated overlap at least a part of the wiring 795 through which the voltage signal VHV2 is propagated.

As a result, it is possible to effectively use the dead space generated in the wiring board 700, and it is possible to achieve size reduction of the wiring board 700 and the print head 21 including the wiring board 700.

The printing data signal SI1 input to the connector 27 is supplied to a wiring 805 formed in the wiring layer L4 through the wiring pattern formed in the wiring layer L1 and the via VH. The printing data signal SI1 supplied to the wiring 805 is propagated through the wiring 805 formed in the wiring layer L4 and a wiring 718 formed in the wiring layer L1 and the via VH that electrically connects the wiring 805 and the wiring 718, and thus is supplied to the electrodes of the electrode group tfg1. As a result, the printing data signal SI1 is input to the ejecting head 22-1.

The printing data signal SI2 input to the connector 27 is supplied to a wiring 807 formed in the wiring layer L4 through the wiring pattern formed in the wiring layer L1 and the via VH. The printing data signal SI2 supplied to the wiring 807 is propagated through the wiring 807 formed in the wiring layer L4 and a wiring 736 formed in the wiring layer L1 and the via VH that electrically connects the wiring 807 and the wiring 736, and thus is supplied to the electrodes of the electrode group tfg2. As a result, the printing data signal SI2 is input to the ejecting head 22-2.

The printing data signal SI3 input to the connector 27 is supplied to a wiring 810 formed in the wiring layer L4 through the wiring pattern formed in the wiring layer L1 and the via VH. The printing data signal SI3 supplied to the wiring 810 is propagated through the wiring 810 formed in the wiring layer L4 and a wiring 751 formed in the wiring layer L1 and the via VH that electrically connects the wiring 810 and the wiring 751, and thus is supplied to the electrodes of the electrode group tfg3. As a result, the printing data signal SI3 is input to the ejecting head 22-3.

The printing data signal SI4 input to the connector 27 is supplied to a wiring 815 formed in the wiring layer L4 through the wiring pattern formed in the wiring layer L1 and the via VH. The printing data signal SI4 supplied to the wiring 815 is propagated through the wiring 815 formed in the wiring layer L4 and a wiring 769 formed in the wiring layer L1 and the via VH that electrically connects the wiring 815 and the wiring 769, and thus is supplied to the electrodes of the electrode group tfg4. As a result, the printing data signal SI4 is input to the ejecting head 22-4.

The clock signal SCK input to the connector 27 is supplied to a wiring 804 formed in the wiring layer L4 through the wiring pattern formed in the wiring layer L1 and the via VH. The clock signal SCK supplied to the wiring 804 is propagated through the wiring 804 formed in the wiring layer L4 and a wiring 717 formed in the wiring layer L1 and the via VH that electrically connects the wiring 804 and the wiring 717, and thus is supplied to the electrodes of the electrode group tfg1. In addition, the clock signal SCK supplied to the wiring 804 is propagated through the wiring 804 formed in the wiring layer L4, a wiring 785 formed in the wiring layer L3, a wiring 735 formed in the wiring layer L1, the via VH that electrically connects the wiring 804 and the wiring 785, and the via VH that electrically connects the wiring 785 and the wiring 735, and thus is supplied to the electrodes of the electrode group tfg2. In addition, the clock signal SCK supplied to the wiring 804 is propagated through the wiring 804 formed in the wiring layer L4, a wiring 792 formed in the wiring layer L3, a wiring 752 formed in the wiring layer L1, the via VH that electrically connects the wiring 804 and the wiring 792, and the via VH that electrically connects the wiring 792 and the wiring 752, and thus is supplied to the electrodes of the electrode group tfg3. In addition, the clock signal SCK supplied to the wiring 804 is propagated through the wiring 804 formed in the wiring layer L4, a wiring 799 formed in the wiring layer L3, a wiring 770 formed in the wiring layer L1, the via VH that electrically connects the wiring 804 and the wiring 799, and the via VH that electrically connects the wiring 799 and the wiring 770, and thus is supplied to the electrodes of the electrode group tfg4. As a result, the clock signal SCK is input to the ejecting heads 22-1 to 22-4.

The latch signal LAT input to the connector 27 is supplied to a wiring 781 formed in the wiring layer L3 through the wiring pattern formed in the wiring layer L1 and the via VH. The latch signal LAT supplied to the wiring 781 is propagated through a wiring 803 formed in the wiring layer L4 and a wiring 716 formed in the wiring layer L1 and the via VH that electrically connects the wiring 781 and the wiring 803, and the via VH that electrically connects the wiring 803 and the wiring 716, and thus is supplied to the electrodes of the electrode group tfg1. In addition, the latch signal LAT supplied to the wiring 781 is propagated through the wiring 803 formed in the wiring layer L4, a wiring 784 formed in the wiring layer L3, a wiring 734 formed in the wiring layer L1, the via VH that electrically connects the wiring 781 and the wiring 803, the via VH that electrically connects the wiring 803 and the wiring 784, and the via VH that electrically connects the wiring 784 and the wiring 734, and thus is supplied to the electrodes of the electrode group tfg2. In addition, the latch signal LAT supplied to the wiring 781 is propagated through the wiring 803 formed in the wiring layer L4, a wiring 793 formed in the wiring layer L3, a wiring 753 formed in the wiring layer L1, the via VH that electrically connects the wiring 781 and the wiring 803, the via VH that electrically connects the wiring 803 and the wiring 793, and the via VH that electrically connects the wiring 793 and the wiring 753, and thus is supplied to the electrodes of the electrode group tfg3. In addition, the latch signal LAT supplied to the wiring 781 is propagated through the wiring 803 formed in the wiring layer L4, a wiring 800 formed in the wiring layer L3, a wiring 771 formed in the wiring layer L1, the via VH that electrically connects the wiring 781 and the wiring 803, the via VH that electrically connects the wiring 803 and the wiring 800, and the via VH that electrically connects the wiring 800 and the wiring 771, and thus is supplied to the electrodes of the electrode group tfg4. As a result, the latch signal LAT is input to the ejecting heads 22-1 to 22-4.

The change signal CH input to the connector 27 is supplied to a wiring 780 formed in the wiring layer L3 through the wiring pattern formed in the wiring layer L1 and the via VH. The change signal CH supplied to the wiring 780 is propagated through a wiring 802 formed in the wiring layer L4 and a wiring 715 formed in the wiring layer L1 and the via VH that electrically connects the wiring 780 and the wiring 802, and the via VH that electrically connects the wiring 802 and the wiring 715, and thus is supplied to the electrodes of the electrode group tfg1. In addition, the change signal CH supplied to the wiring 780 is propagated through the wiring 802 formed in the wiring layer L4, a wiring 783 formed in the wiring layer L3, a wiring 733 formed in the wiring layer L1, the via VH that electrically connects the wiring 780 and the wiring 802, the via VH that electrically connects the wiring 802 and the wiring 783, and the via VH that electrically connects the wiring 783 and the wiring 733, and thus is supplied to the electrodes of the electrode group tfg2. In addition, the change signal CH supplied to the wiring 780 is propagated through the wiring 802 formed in the wiring layer L4, a wiring 794 formed in the wiring layer L3, a wiring 754 formed in the wiring layer L1, the via VH that electrically connects the wiring 780 and the wiring 802, the via VH that electrically connects the wiring 802 and the wiring 794, and the via VH that electrically connects the wiring 792 and the wiring 754, and thus is supplied to the electrodes of the electrode group tfg3. In addition, the change signal CH supplied to the wiring 780 is propagated through the wiring 802 formed in the wiring layer L4, a wiring 801 formed in the wiring layer L3, a wiring 772 formed in the wiring layer L1, the via VH that electrically connects the wiring 780 and the wiring 802, the via VH that electrically connects the wiring 802 and the wiring 801, and the via VH that electrically connects the wiring 801 and the wiring 772, and thus is supplied to the electrodes of the electrode group tfg4. As a result, the change signal CH is input to the ejecting heads 22-1 to 22-4.

The voltage signal VDD1 input to the connector 27 is supplied to a wiring 788 formed in the wiring layer L3 through the wiring pattern formed in the wiring layer L1 and the via VH. The voltage signal VDD1 supplied to the wiring 788 is propagated through a wiring 814 formed in the wiring layer L4, a wiring 779 formed in the wiring layer L3, a wiring 721 formed in the wiring layer L1, the via VH that electrically connects the wiring 788 and the wiring 814, the via VH that electrically connects the wiring 814 and the wiring 779, and the via VH that electrically connects the wiring 779 and the wiring 721, and thus is supplied to the electrodes of the electrode group tfg1. In addition, the voltage signal VDD1 supplied to the wiring 788 is propagated through a wiring 739 formed in the wiring layer L1 and the via VH that electrically connects the wiring 788 and the wiring 739, and thus is supplied to the electrodes of the electrode group tfg2. In addition, the voltage signal VDD1 supplied to the wiring 788 is propagated through the wiring 814 formed in the wiring layer L4, a wiring 789 formed in the wiring layer L3, a wiring 748 formed in the wiring layer L1, the via VH that electrically connects the wiring 788 and the wiring 814, the via VH that electrically connects the wiring 814 and the wiring 789, and the via VH that electrically connects the wiring 789 and the wiring 748, and thus is supplied to the electrodes of the electrode group tfg3. In addition, the voltage signal VDD1 supplied to the wiring 788 is propagated through the wiring 814 formed in the wiring layer L4, a wiring 796 formed in the wiring layer L3, a wiring 766 formed in the wiring layer L1, the via VH that electrically connects the wiring 788 and the wiring 814, the via VH that electrically connects the wiring 814 and the wiring 796, and the via VH that electrically connects the wiring 796 and the wiring 766, and thus is supplied to the electrodes of the electrode group tfg4. As a result, the voltage signal VDD1 is input to the ejecting heads 22-1 to 22-4.

The voltage signal VDD2 input to the connector 27 is supplied to a wiring 787 formed in the wiring layer L3 through the wiring pattern formed in the wiring layer L1 and the via VH. The voltage signal VDD2 supplied to the wiring 787 is propagated through a wiring 813 formed in the wiring layer L4, a wiring 778 formed in the wiring layer L3, a wiring 720 formed in the wiring layer L1, the via VH that electrically connects the wiring 787 and the wiring 813, the via VH that electrically connects the wiring 813 and the wiring 778, and the via VH that electrically connects the wiring 778 and the wiring 720, and thus is supplied to the electrodes of the electrode group tfg1. In addition, the voltage signal VDD2 supplied to the wiring 787 is propagated through a wiring 738 formed in the wiring layer L1 and the via VH that electrically connects the wiring 787 and the wiring 738, and thus is supplied to the electrodes of the electrode group tfg2. In addition, the voltage signal VDD2 supplied to the wiring 787 is propagated through the wiring 813 formed in the wiring layer L4, a wiring 790 formed in the wiring layer L3, a wiring 749 formed in the wiring layer L1, the via VH that electrically connects the wiring 787 and the wiring 813, the via VH that electrically connects the wiring 813 and the wiring 790, and the via VH that electrically connects the wiring 790 and the wiring 749, and thus is supplied to the electrodes of the electrode group tfg3. In addition, the voltage signal VDD2 supplied to the wiring 787 is propagated through the wiring 813 formed in the wiring layer L4, a wiring 797 formed in the wiring layer L3, a wiring 767 formed in the wiring layer L1, the via VH that electrically connects the wiring 787 and the wiring 813, the via VH that electrically connects the wiring 813 and the wiring 797, and the via VH that electrically connects the wiring 797 and the wiring 767, and thus is supplied to the electrodes of the electrode group tfg4. As a result, the voltage signal VDD2 is input to the ejecting heads 22-1 to 22-4.

The temperature state signal XHOT1 output from the temperature abnormality detection circuit 400 included in the ejecting head 22-1 is supplied to the electrodes of the electrode group tfg1. The temperature state signal XHOT1 is propagated through a wiring 719 formed in the wiring layer L1, a wiring 777 formed in the wiring layer L3, a wiring 812 formed in the wiring layer L4, a wiring 786 formed in the wiring layer L3, the via VH that electrically connects the wiring 719 and the wiring 777, the via VH that electrically connects the wiring 777 and the wiring 812, and the via VH that electrically connects the wiring 812 and the wiring 786, and is then supplied to a terminal of the electrode group tcg through the wiring pattern and the via VH, which electrically connect the wiring 786 and the electrodes of the electrode group tcg formed in the wiring layer L1.

In addition, the temperature state signal XHOT2 output from the temperature abnormality detection circuit 400 included in the ejecting head 22-2 is supplied to the electrodes of the electrode group tfg2. The temperature state signal XHOT2 is propagated through a wiring 737 formed in the wiring layer L1, the wiring 786 formed in the wiring layer L3, and the via VH that electrically connects the wiring 737 and the wiring 786, and is then supplied to a terminal of the electrode group tcg through the wiring pattern and the via VH, which electrically connect the wiring 786 and the electrodes of the electrode group tcg formed in the wiring layer L1.

In addition, the temperature state signal XHOT3 output from the temperature abnormality detection circuit 400 included in the ejecting head 22-3 is supplied to the electrodes of the electrode group tfg3. The temperature state signal XHOT3 is propagated through a wiring 750 formed in the wiring layer L1, a wiring 791 formed in the wiring layer L3, the wiring 812 formed in the wiring layer L4, the wiring 786 formed in the wiring layer L3, the via VH that electrically connects the wiring 750 and the wiring 791, the via VH that electrically connects the wiring 791 and the wiring 812, and the via VH that electrically connects the wiring 812 and the wiring 786, and is then supplied to a terminal of the electrode group tcg through the wiring pattern and the via VH, which electrically connect the wiring 786 and the electrodes of the electrode group tcg formed in the wiring layer L1.

In addition, the temperature state signal XHOT4 output from the temperature abnormality detection circuit 400 included in the ejecting head 22-4 is supplied to the electrodes of the electrode group tfg4. The temperature state signal XHOT4 is propagated through a wiring 768 formed in the wiring layer L1, a wiring 798 formed in the wiring layer L3, the wiring 812 formed in the wiring layer L4, the wiring 786 formed in the wiring layer L3, the via VH that electrically connects the wiring 768 and the wiring 798, the via VH that electrically connects the wiring 798 and the wiring 812, and the via VH that electrically connects the wiring 812 and the wiring 786, and is then supplied to a terminal of the electrode group tcg through the wiring pattern and the via VH, which electrically connect the wiring 786 and the electrodes of the electrode group tcg formed in the wiring layer L1.

That is, the temperature state signals XHOT1 to XHOT4 output from the temperature abnormality detection circuits 400 included in the respective ejecting heads 22-1 to 22-4 are propagated through the common wiring pattern in the wiring board 700, and the temperature abnormality detection circuits 400 included in the respective ejecting heads 22-1 to 22-4 are wired and connected. The common wiring pattern through which the temperature state signals XHOT1 to XHOT4 are propagated is electrically connected to the electrode group tcg, so that the temperature state signal XHOT corresponding to the temperature state signals XHOT1 to XHOT4 is output through the connector 27.

Here, in the wiring layer L3, the wirings 785, 792, and 799 through which the clock signal SCK is propagated, the wirings 781, 784, 793, and 800 through which the latch signal LAT is propagated, the wirings 780, 783, 794, and 801 through which the change signal CH is propagated, the wirings 788, 779, 789, and 796 through which the voltage signal VDD1 is propagated, the wirings 787, 778, 790, and 797 through which the voltage signal VDD2 is propagated, and the wirings 777, 786, 791, and 798 through which the temperature state signal XHOT as the temperature state signals XHOT1 to XHOT4 is propagated are positioned on the edge 704 side with respect to the wiring 782 through which the voltage signal VHV1 is propagated and on the edge 703 side with respect to the wiring 795 through which the voltage signal VHV2 is propagated. That is, at least a part of each of the wirings 785, 792, and 799 through which the clock signal SCK is propagated, the wirings 781, 784, 793, and 800 through which the latch signal LAT is propagated, the wirings 780, 783, 794, and 801 through which the change signal CH is propagated, the wirings 788, 779, 789, and 796 through which the voltage signal VDD1 is propagated, the wirings 787, 778, 790, and 797 through which the voltage signal VDD2 is propagated, and the wirings 777, 786, 791, and 798 through which the temperature state signal XHOT is propagated, which are formed in the wiring layer L3, are positioned between the wiring 782 that is formed in the wiring layer L3 and through which the voltage signal VHV1 as the voltage signal VHV is propagated and the wiring 795 that is formed in the wiring layer L3 and through which the voltage signal VHV2 as the voltage signal VHV is propagated, in a direction along the x axis and in a direction from the edge 703 toward the edge 704.

As described above, the voltage value of the voltage signal VHV is larger than the voltage values of the clock signal SCK, the latch signal LAT, the change signal CH, the voltage signal VDD1, the voltage signal VDD2, and the temperature state signal XHOT, which are logic signals. By positioning the wiring pattern through which the clock signal SCK, the latch signal LAT, the change signal CH, the voltage signal VDD1, the voltage signal VDD2, and the temperature state signal XHOT, which are low-voltage logic signals, are propagated between the wiring patterns through which the voltage signals VHV1 and VHV2 as the voltage signal VHV, having a large voltage value, propagate, the wiring pattern through which the voltage signal VHV is propagated functions as a shielding wiring that shields, from an external noise, the wiring pattern through which the logic signals propagate. As a result, the possibility that the external noise is superimposed on the wiring pattern through which the clock signal SCK, the latch signal LAT, the change signal CH, the voltage signal VDD1, the voltage signal VDD2, and the temperature state signal XHOT are propagated is reduced. Therefore, the signal accuracy of the clock signal SCK, the latch signal LAT, the change signal CH, the voltage signal VDD1, the voltage signal VDD2, and the temperature state signal XHOT propagated through the wiring board 700 is improved.

In addition, in the wiring layer L4, the wiring 805 through which the printing data signal SI1 is propagated, the wiring 807 through which the printing data signal SI2 is propagated, the wiring 810 through which the printing data signal SI3 is propagated, the wiring 815 through which the printing data signal SI4 is propagated, the wiring 804 through which the clock signal SCK is propagated, the wiring 803 through which the latch signal LAT is propagated, the wiring 802 through which the change signal CH is propagated, the wiring 814 through which the voltage signal VDD1 is propagated, the wiring 813 through which the voltage signal VDD2 is propagated, and the wiring 812 through which the temperature state signal XHOT as the temperature state signals XHOT1 to XHOT4 is propagated are positioned on the edge 704 side with respect to the wiring 806 through which the drive signal COMB1 is propagated and the wiring 807 through which the drive signal COMB2 is propagated, and on the edge 703 side with respect to the wiring 809 through which the drive signal COMB3 is propagated and the wiring 811 through which the drive signal COMB4 is propagated. That is, at least a part of each of the wiring 805 through which the printing data signal SI1 is propagated, the wiring 807 through which the printing data signal SI2 is propagated, the wiring 810 through which the printing data signal SI3 is propagated, the wiring 815 through which the printing data signal SI4 is propagated, the wiring 804 through which the clock signal SCK is propagated, the wiring 803 through which the latch signal LAT is propagated, the wiring 802 through which the change signal CH is propagated, the wiring 814 through which the voltage signal VDD1 is propagated, the wiring 813 through which the voltage signal VDD2 is propagated, and the wiring 812 through which the temperature state signal XHOT is propagated, which are formed in the wiring layer L4, are positioned between the wiring 806 that is formed in the wiring layer L4 and through which the drive signal COMB1 is propagated or the wiring 807 that is formed in the wiring layer L4 and through which the drive signal COMB2 is propagated and the wiring 809 that is formed in the wiring layer L4 and through which the drive signal COMB3 is propagated or the wiring 811 that is formed in the wiring layer L4 and through which the drive signal COMB4 is propagated, in a direction along the x axis and in a direction from the edge 703 toward the edge 704.

As described above, the drive signals COMB1 to COMB4 are signals generated by performing class-D amplification of the signal waveforms defined by the base drive signals dB1 to dB4 in response to the voltage signal VHV having a high voltage. Therefore, the voltage values of the drive signals COMB1 to COMB4 are larger than the voltage values of the printing data signals SI1 to SI4, the clock signal SCK, the latch signal LAT, the change signal CH, the voltage signal VDD1, the voltage signal VDD2, and the temperature state signal XHOT, which are logic signals. By positioning the wiring patterns through which the printing data signals SI1 to SI4, the clock signal SCK, the latch signal LAT, the change signal CH, the voltage signal VDD1, the voltage signal VDD2, and the temperature state signal XHOT, which are low-voltage logic signals, are propagated between the wiring patterns through which the drive signals COMB1 to COMB4 having a large voltage value propagate, the wiring pattern through which the drive signals COMB1 to COMB4 are propagated functions as a shielding wiring that shields, from an external noise, the wiring pattern through which the logic signals propagate. As a result, the possibility that the external noise is superimposed on the wiring patterns through which the printing data signals SI1 to SI4, the clock signal SCK, the latch signal LAT, the change signal CH, the voltage signal VDD1, the voltage signal VDD2, and the temperature state signal XHOT are propagated is reduced. Therefore, the signal accuracy of the printing data signals SI1 to SI4, the clock signal SCK, the latch signal LAT, the change signal CH, the voltage signal VDD1, the voltage signal VDD2, and the temperature state signal XHOT propagated through the wiring board 700 is improved.

That is, in the wiring board 700 of the liquid ejecting apparatus 1 according to the present embodiment, in the wiring layers L3 and L4, the wiring patterns through which the printing data signals SI1 to SI4, the clock signal SCK, the latch signal LAT, the change signal CH, the voltage signal VDD1, the voltage signal VDD2, and the temperature state signal XHOT, which are the low-voltage logic signals, are propagated are positioned between the wiring patterns through which the voltage signal VHV and the drive signals COMA1 to COMA4 and COMB1 to COMB4, having a high voltage, are propagated, in a direction along the y axis orthogonal to the direction along the x axis from the edge 703 toward the edge 704. As a result, the signal accuracy of the printing data signals SI1 to SI4, the clock signal SCK, the latch signal LAT, the change signal CH, the voltage signal VDD1, the voltage signal VDD2, and the temperature state signal XHOT propagated through the wiring board 700 is improved.

In addition, the wiring board 700 includes wirings pg1 and pg2 through which the signal of the ground potential input through the connector 27 is propagated. The wiring pg1 is formed in the wiring layer L1, and the signal of the ground potential input through the connector 27 is propagated through the wiring pg1. The wiring pg2 is provided in the wiring layer L2 that is adjacent to the wiring layer L1 in the stacking direction. In this case, the wiring pg2 through which the signal of the ground potential is propagated is provided over substantially the entire surface of the wiring layer L2.

The wiring layer L1 on which the connector 27 is provided is electrically connected to a configuration outside the print head 21, and thus is likely to be affected by the external noise. On the other hand, by extending the wiring pg2 through which the signal of the ground potential is propagated over substantially the entire surface of the wiring layer L2 between the wiring layer L1 and the wiring layers L3 to L6 through which the printing data signals SI1 to SI4, the clock signal SCK, the latch signal LAT, the change signal CH, the voltage signal VDD1, the voltage signal VDD2, the temperature state signal XHOT, the drive signals COMA1 to COMA4 and COMA1 to COMB4, and the reference voltage signals VBS1 to VBS4 propagate, the wiring pg2 functions as a shielding layer that shields between the wiring layer L1 and the wiring layers L3 to L6. As a result, the possibility that the external noise interferes with the printing data signals SI1 to SI4, the clock signal SCK, the latch signal LAT, the change signal CH, the voltage signal VDD1, the voltage signal VDD2, the temperature state signal XHOT, the drive signals COMA1 to COMA4 and COMA1 to COMB4, and the reference voltage signals VBS1 to VBS4, which are propagated through the wiring layers L3 to L6, is reduced. Therefore, the signal accuracy of the printing data signals SI1 to SI4, the clock signal SCK, the latch signal LAT, the change signal CH, the voltage signal VDD1, the voltage signal VDD2, the temperature state signal XHOT, the drive signals COMA1 to COMA4 and COMA1 to COMB4, and the reference voltage signals VBS1 to VBS4, which are propagated through the wiring layers L3 to L6, is improved.

Here, the wiring pg2 through which the signal of the ground potential is propagated extending over substantially the entire surface of the wiring layer L2 is not limited to the case in which the wiring pg2 extends over the entire surface of the wiring layer L2 and there is no other wiring pattern in the wiring layer L2; and a wiring pattern other than the wiring pattern through which the signal of the ground potential is propagated may be provided in the wiring layer L2. In this case, an area of the wiring pg2 through which the signal of the ground potential is propagated may be 80% or more of the total area of the wiring patterns formed in the wiring layer L2. In addition, the wiring board 700 may include a plurality of wiring patterns through which the signal of the ground potential is propagated in the wiring layers L1 to L6, in addition to the wirings pg1 and pg2.

In addition, the signal of the ground potential input through the connector 27 is also supplied to each of the ejecting heads 22-1 to 22-4 through terminals included in each of the electrode groups tfg1 to tfg4. For example, the signal of the ground potential propagated through the wiring pg2 is supplied to the terminals included in each of the electrode groups tfg1 to tfg4 through a wiring pattern that electrically connects the wiring pg2 and the electrodes included in each of the electrode groups tfg1 to tfg4 formed in the wiring layer L1 and the via VH that electrically connects the wiring pg2 and the wiring patterns, so that the signal of the ground potential is supplied to the ejecting heads 22-1 to 22-4.

In this case, it is preferable that the via VH that electrically connects the wiring patterns electrically connecting the wiring pg2 and the electrodes included in each of the electrode groups tfg1 to tfg4 formed in the wiring layer L1 is positioned between the electrode groups tfg1 to tfg4 and the wiring patterns through which the printing data signals SI1 to SI4, the clock signal SCK, the latch signal LAT, the change signal CH, the voltage signal VDD1, the voltage signal VDD2, and the temperature state signal XHOT are propagated, in a direction from the edge 703 toward the edge 704.

That is, it is preferable that the via VH through which the ground potential supplied to the ejecting head 22-1 is propagated is positioned between the electrode group tfg1 to which one end of the flexible substrate 28-1 is electrically connected and the wiring patterns through which the printing data signals SI1 to SI4, the clock signal SCK, the latch signal LAT, the change signal CH, the voltage signal VDD1, the voltage signal VDD2, and the temperature state signal XHOT are propagated; the via VH through which the ground potential supplied to the ejecting head 22-2 is propagated is positioned between the electrode group tfg2 to which one end of the flexible substrate 28-2 is electrically connected and the wiring patterns through which the printing data signals SI1 to SI4, the clock signal SCK, the latch signal LAT, the change signal CH, the voltage signal VDD1, the voltage signal VDD2, and the temperature state signal XHOT are propagated; the via VH through which the ground potential supplied to the ejecting head 22-3 is propagated is positioned between the electrode group tfg3 to which one end of the flexible substrate 28-3 is electrically connected and the wiring patterns through which the printing data signals SI1 to SI4, the clock signal SCK, the latch signal LAT, the change signal CH, the voltage signal VDD1, the voltage signal VDD2, and the temperature state signal XHOT are propagated; and the via VH through which the ground potential supplied to the ejecting head 22-4 is propagated is positioned between the electrode group tfg4 to which one end of the flexible substrate 28-4 is electrically connected and the wiring patterns through which the printing data signals SI1 to SI4, the clock signal SCK, the latch signal LAT, the change signal CH, the voltage signal VDD1, the voltage signal VDD2, and the temperature state signal XHOT are propagated.

In the vicinity of the electrode groups tfg1 to tfg4 to which the flexible substrates 28-1 to 28-4 are electrically connected, a large number of wiring patterns are densely provided, and thus the temperature is likely to rise. By disposing the via VH through which the signal of the ground potential that is unlikely to increase in temperature is propagated in the vicinity of the electrode groups tfg1 to tfg4 in which the temperature is likely to rise, the heat generated in the vicinity of the electrode groups tfg1 to tfg4 is released to the wiring pattern through which the signal of the ground potential is propagated, and as a result, the amount of increase in temperature in the vicinity of the electrode groups tfg1 to tfg4 can be reduced.

Furthermore, although not illustrated, a filter circuit may be electrically connected to the wiring patterns through which the printing data signals SI1 to SI4, the clock signal SCK, the latch signal LAT, the change signal CH, the voltage signal VDD1, the voltage signal VDD2, and the temperature state signal XHOT are propagated, for the purpose of reducing the noise superimposed on the wiring pattern. That is, in the wiring board 700, a filter circuit may be provided in a propagation path through which the printing data signals SI1 to SI4, the clock signal SCK, the latch signal LAT, the change signal CH, the voltage signal VDD1, the voltage signal VDD2, and the temperature state signal XHOT propagate. As a result, the possibility that the noise is superimposed on the printing data signals SI1 to SI4, the clock signal SCK, the latch signal LAT, the change signal CH, the voltage signal VDD1, the voltage signal VDD2, and the temperature state signal XHOT is reduced, and the signal accuracy of the printing data signals SI1 to SI4, the clock signal SCK, the latch signal LAT, the change signal CH, the voltage signal VDD1, the voltage signal VDD2, and the temperature state signal XHOT can be improved.

In this case, it is preferable that the filter circuit provided in the propagation path through which the printing data signals SI1 to SI4, the clock signal SCK, the latch signal LAT, the change signal CH, the voltage signal VDD1, the voltage signal VDD2, and the temperature state signal XHOT are propagated is provided in the wiring layer L6 and is mounted on the surface 702 of the wiring board 700. As described above, the electrode group tcg to which the connector 27 is electrically connected and the electrode groups tfg1 to tfg4 to which the flexible substrates 28-1 to 28-4 are electrically connected are provided on the surface 701 of the wiring board 700. In such a wiring board 700, by providing the above-described filter circuit on the surface 702 of the wiring board 700, the possibility that the wiring board 700 is increased in size is reduced.

Furthermore, it is preferable that the filter circuit provided in the propagation path through which the printing data signals SI1 to SI4, the clock signal SCK, the latch signal LAT, the change signal CH, the voltage signal VDD1, the voltage signal VDD2, and the temperature state signal XHOT are propagated is positioned in a region of the surface 702 of the wiring board 700, which does not overlap the electrode groups tfg1 to tfg4 as viewed from the stacking direction of the wiring board 700.

When the flexible substrates 28-1 to 28-4 are electrically connected to the electrode groups tfg1 to tfg-4, from the viewpoint of improving workability, the wiring board 700 is held in a region of the wiring board 700 which overlaps the electrode groups tfg1 to tfg4 in the stacking direction of the wiring board 700. In this case, by positioning the filter circuit provided in the propagation path through which the printing data signals SI1 to SI4, the clock signal SCK, the latch signal LAT, the change signal CH, the voltage signal VDD1, the voltage signal VDD2, and the temperature state signal XHOT are propagated in the region of the surface 702 of the wiring board 700, which does not overlap the electrode groups tfg1 to tfg4 as viewed from the stacking direction of the wiring board 700, the possibility that the filter circuit hinders the workability when the flexible substrates 28-1 to 28-4 are electrically connected to the electrode groups tfg1 to tfg-4 is reduced.

That is, in the wiring board 700, the filter circuit may be provided in the propagation path through which the printing data signals SI1 to SI4, the clock signal SCK, the latch signal LAT, the change signal CH, the voltage signal VDD1, the voltage signal VDD2, and the temperature state signal XHOT are propagated; and in this case, it is preferable that, in the surface 702 of the wiring board 700, the filter circuit is provided at a position that does not overlap the electrode group tfg1 of the wiring board 700 to which one end of the flexible substrate 28-1 is electrically connected, the electrode group tfg2 of the wiring board 700 to which one end of the flexible substrate 28-2 is electrically connected, the electrode group tfg3 of the wiring board 700 to which one end of the flexible substrate 28-3 is electrically connected, and the electrode group tfg4 of the wiring board 700 to which one end of the flexible substrate 28-4 is electrically connected, as viewed from the normal direction of the wiring board 700 in the stacking direction. As a result, the signal accuracy of the printing data signals SI1 to SI4, the clock signal SCK, the latch signal LAT, the change signal CH, the voltage signal VDD1, the voltage signal VDD2, and the temperature state signal XHOT propagated through the wiring board 700 can be improved without hindering the workability when the flexible substrates 28-1 to 28-4 are electrically connected to the electrode groups tfg1 to tfg-4, and in a state in which the possibility that the wiring board 700 is increased in size is reduced.

The filter circuit may be provided to correspond to all the propagation paths of the printing data signals SI1 to SI4, the clock signal SCK, the latch signal LAT, the change signal CH, the voltage signal VDD1, the voltage signal VDD2, and the temperature state signal XHOT, or may be provided only in some of the propagation paths of the printing data signals SI1 to SI4, the clock signal SCK, the latch signal LAT, the change signal CH, the voltage signal VDD1, the voltage signal VDD2, and the temperature state signal XHOT.

### 3.3.2. Disposition of via in wiring layer

Here, in a printed circuit board such as the wiring board 700, short-circuit abnormality may occur between conductive portions due to growth of migration. The migration grows when a potential difference continuously occur between the conductive portions disposed in the vicinity of each other, and particularly grows significantly in a high-temperature and high-humidity environment. On the other hand, in the liquid ejecting apparatus 1 that ejects the liquid such as the ink onto the medium P to form an image, a part of the ejected liquid floats as a fine mist inside the liquid ejecting apparatus 1, so that the inside of the apparatus may be the high-temperature and high-humidity environment, and thus the inside of the liquid ejecting apparatus 1 may be an environment in which the migration is likely to grow. Therefore, in the liquid ejecting apparatus 1, a strong measure against the short-circuit abnormality that may occur between the conductive portions as the migration grows is required.

In response to such requirements, in the wiring board 700 included in the liquid ejecting apparatus 1 according to the present embodiment, the vias VH that penetrate the wiring layers L1 to L6 and the insulating layers. IS1 to IS5 are disposed such that the short-circuit abnormality is unlikely to occur between the conductive portions even when the migration grows. As a result, even when the wiring board 700 is disposed in an environment in which the migration is likely to grow, a concern that the short-circuit abnormality occurs between the conductive portions of the wiring board 700 is reduced.

In describing the configuration of such a wiring board 700, first, a configuration of a glass cloth GC included in each of the insulating layers IS1 to IS5 of the wiring board 700 and a relationship with a growth direction of the migration will be described. Here, in the following description, when it is not necessary to distinguish between the insulating layers IS1 to IS5, the insulating layers IS1 to IS5 may be simply referred to as an insulating layer IS. In addition, in the following description, an h axis and a v axis orthogonal to each other will be used. The h axis and the v axis are axes extending in directions independent of the x axis, the y axis, the X axis, the Y axis, and the Z axis described above; but in the liquid ejecting apparatus 1 according to the present embodiment, the description will be made on the assumption that the h axis extends along the x axis described above and the v axis extends along the y axis described above.

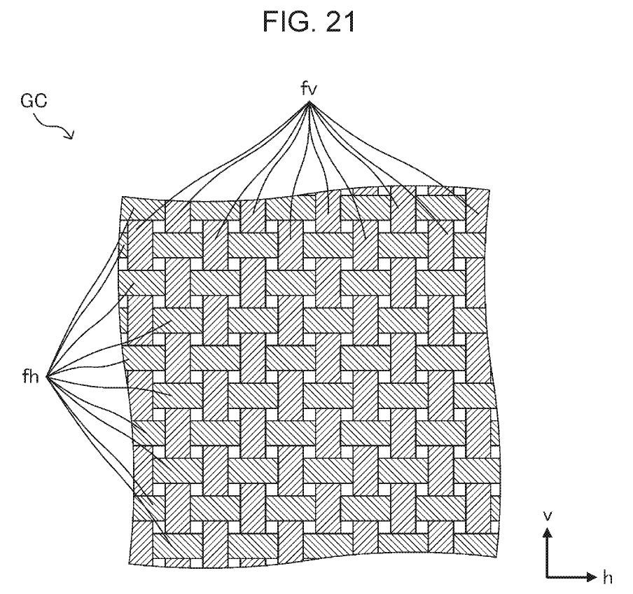

FIG. 21 is a view for explaining a configuration of the glass cloth GC contained in the insulating layer IS of the wiring board 700. As illustrated in FIG. 21, the glass cloth GC contained in the insulating layer IS includes a plurality of glass fibers fh extending along the h axis and a plurality of glass fibers fv extending along the v axis. The glass cloth GC is formed by interweaving the plurality of glass fibers fh and the plurality of glass fibers fv as illustrated in FIG. 21, the glass cloth GC in which the plurality of glass fibers fh and the plurality of glass fibers fv are interwoven is impregnated with a resin, and then a heating treatment or the like is performed, so that the insulating layer IS is formed.

In the insulating layer IS, a gap between the glass cloth GC in which the glass fibers fh and the glass fibers fv are interwoven is impregnated with the resin, and thus, ideally, the migration does not grow in the insulating layer IS. That is, in the insulating layer IS inside the wiring board 700, the migration does not grow ideally. Therefore, ideally, the short-circuit abnormality of the conductive portions due to the growth of the migration does not occur in the insulating layer IS inside the wiring board 700.

However, in some cases, a so-called hollow fiber in which the inside is hollow may be mixed in a part of the plurality of glass fibers fh and the plurality of glass fibers fv constituting the glass cloth GC. When the hollow fiber is mixed in the glass fibers fh and fv constituting the glass cloth GC, the migration grows inside the hollow fiber, and thus the short-circuit abnormality in which the conductive portions are short-circuited may occur in the insulating layer IS inside the wiring board 700. In this case, the migration grows in the insulating layer IS inside the wiring board 700, and thus it is difficult to visually check the growth; and even when periodic inspection is performed, sudden abnormality may occur in the liquid ejecting apparatus 1, and thus the productivity in the liquid ejecting apparatus 1 may be significantly reduced.

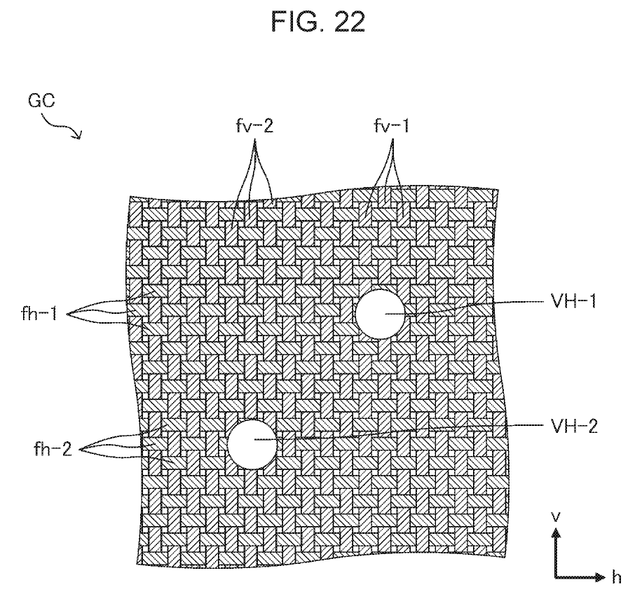

FIG. 22 is a view illustrating an example of a disposition of the vias VH that reduce the concern that short-circuit abnormality occurs due to the growth of migration in the wiring board 700. In FIG. 22, one of the plurality of vias VH is illustrated as a via VH-1, and a different one of the plurality of vias VH is illustrated as a via VH-2. Here, the via VH-2 is a via VH that is positioned in the vicinity of the via VH-1 and propagates a signal having a different potential from the via VH-1. Here, the via VH-2 being positioned in the vicinity of the via VH-1 includes a case where a wiring pattern that is not electrically connected to the via VH-1 and the via VH-2 is not positioned between the via VH-1 and the via VH-2 on an imaginary straight line linking the via VH-1 and the via VH-2, and a case where a circuit element is not provided between the via VH-1 and the via VH-2 on the imaginary straight line linking the via VH-1 and the via VH-2.

As illustrated in FIG. 22, the via VH-1 is formed to penetrate a plurality of glass fibers fh-1 in the plurality of glass fibers fh extending along the h axis and a plurality of glass fibers fv-1 in the plurality of glass fibers fv extending along the v axis, in the wiring board 700. The via VH-2 is formed to penetrate a plurality of glass fibers fh-2 in the plurality of glass fibers fh extending along the h axis and a plurality of glass fibers fv-2 in the plurality of glass fibers fv extending along the v axis, in the wiring board 700. That is, the via VH-1 is disposed at a position that does not penetrate the plurality of glass fibers fh-2 and the plurality of glass fibers fv-2 penetrated by the via VH-2, and the via VH-2 is disposed at a position that does not penetrate the plurality of glass fibers fh-1 and the plurality of glass fibers fv-1 penetrated by the via VH-1. In other words, the via VH-1 penetrates the plurality of glass fibers fh-1 and the plurality of glass fibers fv-1, and propagates any signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700; and the via VH-2 does not penetrate the plurality of glass fibers fh-1 and the plurality of glass fibers fv-1, and propagates a signal having a different voltage value from the signal that propagates through the via VH-1 and is any different signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700.

In the wiring board 700 in which the vias VH-1 and VH-2 are disposed as described above, even when the hollow fiber is mixed in the glass fibers fh and fv included in the glass cloth GC of the insulating layer IS and the migration that occurs in the via VH-1 or the via VH-2 grows inside the hollow fiber, the glass fibers fh and fv in which the hollow fiber is included and in which the migration grows inside the hollow fiber do not come into contact with at least one of the via VH-1 or the via VH-2, and thus the concern that the via VH-1 and the via VH-2 are short-circuited as the migration grows is reduced. That is, the concern that the short-circuit abnormality between the conductive portions due to the growth of the migration occurs in the insulating layer IS inside the wiring board 700 is reduced.

Therefore, even when the potential difference continuously occur between the via VH-1 and the via VH-2 positioned in the vicinity of the via VH-1 because the signal of the ground potential propagates through the via VH-1, when the large potential difference continuously occur between the via VH-1 and the via VH-2 positioned in the vicinity of the via VH-1 because the signal of the ground potential is supplied to the via VH-1 and the high-voltage voltage signal VHV used for generating the drive signals COMA and COMB is supplied to the via VH-2, or when the drive signal COMA or the drive signal COMB is supplied to the via VH-1 and the reference voltage signal VBS is supplied to the via VH-2, the concern that the via VH-1 and the via VH-2 are short-circuited as the migration grows in at least one of the via VH-1 or the via VH-2 is reduced. As a result, the concern that the short-circuit abnormality between the conductive portions due to the growth of the migration occurs in the insulating layer IS inside the wiring board 700 is reduced.

Here, the wiring board 700 includes the insulating layers IS1 to IS5 as the insulating layer IS. As described above, each of the insulating layers IS1 to IS5 is configured by performing the heating treatment or the like after impregnating the glass cloth woven with the glass fibers with a resin. Therefore, each of the insulating layers IS1 to IS5 includes the glass fibers fh and the glass fibers fv. In this case, it is preferable that the glass fibers fh contained in each of the insulating layers IS1 to IS5 extend in substantially the same direction in the insulating layers IS1 to IS5, and the glass fibers fv contained in each of the insulating layers IS1 to IS5 extend in substantially the same direction in the insulating layers IS1 to IS5. That is, a direction in which the glass fibers fh contained in the insulating layer IS1 extend, a direction in which the glass fibers fh contained in the insulating layer IS2 extend, a direction in which the glass fibers fh contained in the insulating layer IS3 extend, a direction in which the glass fibers fh contained in the insulating layer IS4 extend, and a direction in which the glass fibers fh contained in the insulating layer IS5 extend are substantially the same; and a direction in which the glass fibers fv contained in the insulating layer IS1 extend, a direction in which the glass fibers fv contained in the insulating layer IS2 extend, a direction in which the glass fibers fv contained in the insulating layer IS3 extend, a direction in which the glass fibers fv contained in the insulating layer IS4 extend, and a direction in which the glass fibers fv contained in the insulating layer IS5 extend are substantially the same.

As a result, when the via VH-1 does not penetrate the plurality of glass fibers fh-2 and the plurality of glass fibers fv-2 penetrated by the via VH-2 in the insulating layer IS1, the via VH-1 does not penetrate the plurality of glass fibers fh and the plurality of glass fibers fv penetrated by the via VH-1 in the insulating layers IS2 to IS5; and when the via VH-2 does not penetrate the plurality of glass fibers fh-1 and the plurality of glass fibers fv-1 penetrated by the via VH-1 in the insulating layer IS1, the via VH-2 does not penetrate the plurality of glass fibers fh and the plurality of glass fibers fv penetrated by the via VH-1 in the insulating layers IS2 to IS5. Therefore, the concern that the short-circuit abnormality between the conductive portions due to the growth of the migration occurs in any of the insulating layers IS1 to IS5 inside the wiring board 700 is also reduced.

Here, the transport unit 40 is an example of the transport portion; the wiring board 700 is an example of the multilayer substrate; the electrode 611 included in the piezoelectric element 60 is an example of the first electrode; the electrode 612 included in the piezoelectric element 60 is an example of the second electrode; the wiring layer L1 is an example of the first wiring layer; the wiring layer L6 is an example of the second wiring layer; any of the wiring layers L2 to L5 is an example of the third wiring layer; the wiring layers L1 to L6 are an example of the plurality of wiring layers; the insulating layer IS1 is an example of the first insulating layer; the insulating layer IS5 is an example of the second insulating layer; any of the plurality of vias VH as the via VH-1 is an example of the first through wiring; any different one of the plurality of vias VH as the via VH-2 is an example of the second through wiring; the plurality of glass fibers fh-1 and fv-1, which are penetrated by the via VH-1, among the plurality of glass fibers fh and fv contained in the insulating layer IS1 are examples of the first glass fiber; and the plurality of glass fibers fh-1 and fv-1, which are penetrated by the via VH-1, among the plurality of glass fibers fh and fv contained in the insulating layer IS5 are examples of the second glass fiber. In addition, the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4 are examples of the plurality of ejection control signals; any of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4 are examples of the first ejection control signal; any different one of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4 are examples of the second ejection control signal; the voltage signal VHV is an example of the amplified power supply voltage signal; and the drive signals COMA and COMB and the drive signal VOUT are examples of the drive signal.

### 4. Action and effect

In the liquid ejecting apparatus 1 according to the present embodiment configured as above, regarding the wiring board 700 included in the print head 21 of the head unit 20, the via VH-1 among the plurality of vias VH penetrates the plurality of glass fibers fh-1 and the plurality of glass fibers fv-1, and propagates any signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700; and the via VH-2 among the plurality of vias VH does not penetrate the plurality of glass fibers fh-1 and the plurality of glass fibers fv-1, and propagates a signal having a different voltage value from the signal that propagates through the via VH-1 and is any different signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700.

As a result, even when the hollow fiber is mixed in the glass fibers fh and fv contained in the glass cloth GC of the insulating layer IS and the migration that occurs in the via VH-1 or the via VH-2 grows inside the hollow fiber, the glass fibers fh and fv in which the hollow fiber is included and in which the migration grows inside the hollow fiber do not come into contact with at least one of the via VH-1 or the via VH-2, and thus the concern that the via VH-1 and the via VH-2 are short-circuited as the migration grows is reduced. That is, the concern that the short-circuit abnormality between the conductive portions due to the growth of the migration occurs in the insulating layer IS inside the wiring board 700 is reduced.

### Second embodiment

Next, a liquid ejecting apparatus 1 according to a second embodiment will be described. In describing the liquid ejecting apparatus 1 according to the second embodiment, the same reference numerals will be given to the same configurations as those of the liquid ejecting apparatus 1 according to the first embodiment, and the description thereof will be simplified or not be repeated. In the liquid ejecting apparatus 1 according to the second embodiment, a disposition of the vias VH that reduce the concern that the short-circuit abnormality occurs due to the growth of the migration in the wiring board 700 included in the print head 21 of the head unit 20 is different from that in the liquid ejecting apparatus 1 according to the first embodiment.

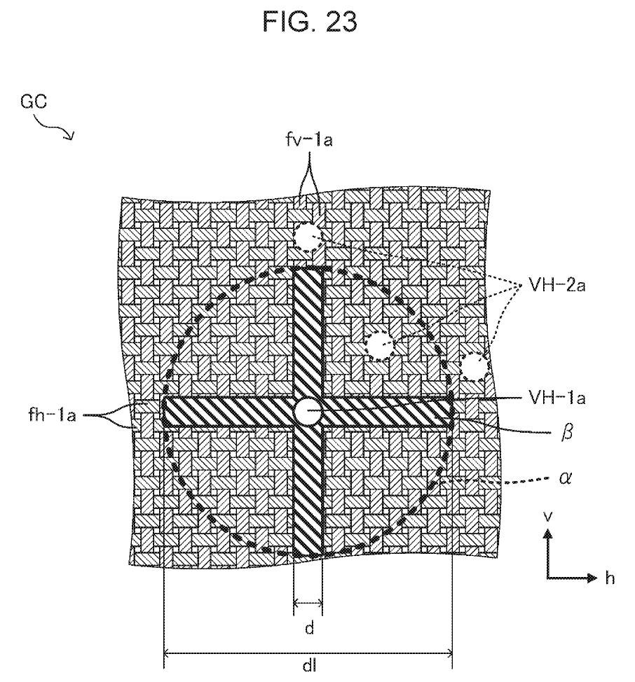

FIG. 23 is a view for explaining a disposition of the vias VH that can reduce a concern that short-circuit abnormality occurs due to growth of migration in the wiring board 700 included in the liquid ejecting apparatus 1 according to the second embodiment. In FIG. 23, when a via VH-1a is provided in the wiring board 700, an example of the disposition of the vias VH that can be provided is illustrated as a via VH-2a with a broken line.

In the liquid ejecting apparatus 1 according to the second embodiment, the via VH-1a penetrates a plurality of glass fibers fh-1a and a plurality of glass fibers fv-1a, and propagates any signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700. In this case, the via VH-2a is disposed in a region α having a diameter dl that is 5 times a diameter d of the via VH-1a, centered on the via VH-1a, and in a region other than a forbidden region β in which the plurality of glass fibers fh-1a and the plurality of glass fibers fv-1a are positioned.

That is, in the liquid ejecting apparatus 1 according to the second embodiment, the via VH-1a penetrates the plurality of glass fibers fh-1a and the plurality of glass fibers fv-1a, and propagates any signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700; and the via VH-2a does not penetrate the plurality of glass fibers fh-1a and the plurality of glass fibers fv-1a in the region α having a diameter dl that is 5 times a diameter d of the via VH-1a, centered on the via VH-1a, and propagates a signal having a different voltage value from the signal that propagates through the via VH-1 and is any different signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700.

When a distance between the via VH-1a and the via VH-2a is spaced by 5 times or more the diameter d of the via VH-1a, the concern that the via VH-1a and the via VH-2a are electrically connected due to the growth of the migration is reduced, and the distance between the via VH-1a and the via VH-2a is increased, so that an intensity of an electric field generated between the via VH-1a and the via VH-2a is reduced, and a rate at which the migration grows between the via VH-1a and the via VH-2a is reduced. Therefore, when the distance between the via VH-1a and the via VH-2a is spaced by 5 times or more the diameter d of the via VH-1a, the concern that the short-circuit abnormality between the conductive portions due to the growth of the migration occurs between the via VH-1a and the via VH-2a is significantly reduced.

As a result, even in the liquid ejecting apparatus 1 according to the second embodiment in which the via VH-1a penetrates the plurality of glass fibers fh-1a and the plurality of glass fibers fv-1a, and propagates any signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700; and the via VH-2a does not penetrate the plurality of glass fibers fh-1a and the plurality of glass fibers fv-1a in the region α having a diameter dl that is 5 times a diameter d of the via VH-1a, centered on the via VH-1a, and propagates a signal having a different voltage value from the signal that propagates through the via VH-1 and is any different signal of the printing data signals SI1 to SI4, the clock signal SCK, the latch signal LAT, the change signal CH, the voltage signal VDD1, the voltage signal VDD2, the temperature state signal XHOT, the voltage signal VHV, the drive signals COMA1 to COMA4 and COMB1 to COMB4, and the reference voltage signals VBS1 to VBS4, which are propagated through the wiring board 700, the same effects as those of the liquid ejecting apparatus 1 according to the first embodiment can be achieved. Furthermore, in the liquid ejecting apparatus 1 according to the second embodiment, the disposition constraint of the vias VH in the wiring board 700 is relaxed as compared with the liquid ejecting apparatus 1 according to the first embodiment, and thus the degree of freedom of the wiring pattern in the wiring board 700 is improved, and as a result, the reduction in size of the wiring board 700 can also be achieved.

The embodiments and the modification examples have been described, but the present disclosure is not limited to the embodiments, and can be implemented in various aspects within the scope not departing from the concept of the present disclosure. For example, the embodiments described above can also be combined with each other as appropriate.

The present disclosure includes substantially the same configurations (for example, configurations having the same functions, methods, and results, or configurations having the same objects and effects) as the configurations described in the embodiments. In addition, the present disclosure includes configurations in which non-essential parts of the configuration described in the embodiments are replaced. In addition, the present disclosure includes configurations that achieve the same operational effects or configurations that can achieve the same objects as those of the configurations described in the embodiments. In addition, the present disclosure includes configurations in which a known technology is added to the configurations described in the embodiments.

The following contents are derived from the above-described embodiments.

An aspect of the liquid ejecting apparatus including:

a transport portion configured to transport a medium; and

a head unit configured to eject a liquid onto the medium in response to a plurality of ejection control signals,

in which the head unit includes a multilayer substrate in which a plurality of wiring layers that propagate the plurality of ejection control signals are stacked,

the multilayer substrate includes

a first wiring layer and a second wiring layer among the plurality of wiring layers,

a first insulating layer that is positioned between the first wiring layer and the second wiring layer along a stacking direction in which the plurality of wiring layers are stacked, and

a first through wiring and a second through wiring, which penetrate the first insulating layer,

the first insulating layer contains a plurality of glass fibers including a first glass fiber,

the first through wiring penetrates the first glass fiber and propagates a first ejection control signal among the plurality of ejection control signals, and

the second through wiring does not penetrate the first glass fiber and propagates a second ejection control signal different from the first ejection control signal in voltage value among the plurality of ejection control signals.

According to the liquid ejecting apparatus, the concern that the short-circuit abnormality due to the growth of the migration occurs between the first through wiring and the second through wiring is reduced even when the first glass fiber is the hollow fiber in which the inside is hollow and the migration grows inside the hollow fiber, because the second through wiring does not penetrate the first glass fiber penetrated by the first through wiring.

An aspect of the liquid ejecting apparatus including:

a transport portion configured to transport a medium; and

a head unit configured to eject a liquid onto the medium in response to a plurality of ejection control signals,

in which the head unit includes a multilayer substrate in which a plurality of wiring layers that propagate the plurality of ejection control signals are stacked,

the multilayer substrate includes

a first wiring layer and a second wiring layer among the plurality of wiring layers,

a first insulating layer that is positioned between the first wiring layer and the second wiring layer along a stacking direction in which the plurality of wiring layers are stacked, and

a first through wiring and a second through wiring, which penetrate the first insulating layer,

the first insulating layer contains a plurality of glass fibers including a first glass fiber,

the first through wiring penetrates the first glass fiber and propagates a first ejection control signal among the plurality of ejection control signals, and

the second through wiring does not penetrate the first glass fiber in a region having a diameter smaller than 5 times a diameter of the first through wiring, centered on the first through wiring, and propagates a second ejection control signal different from the first ejection control signal in voltage value among the plurality of ejection control signals.

According to the liquid ejecting apparatus, the second through wiring does not penetrate the first glass fiber in a region having a diameter smaller than 5 times a diameter of the first through wiring, centered on the first through wiring. That is, when the second through wiring is positioned in the vicinity of the first through wiring that penetrates the first glass fiber, the second through wiring is disposed in the multilayer substrate such that the second through wiring does not penetrate the first glass fiber penetrated by the first through wiring. As a result, the concern that the short-circuit abnormality due to the growth of the migration occurs between the first through wiring and the second through wiring is reduced even when the first glass fiber is the hollow fiber in which the inside is hollow and the migration grows inside the hollow fiber. In addition, when the second through wiring is positioned away from the first through wiring that penetrates the first glass fiber, the migration is unlikely to grow between the first through wiring and the second through wiring, and thus the second through wiring is disposed in the multilayer substrate regardless of the first glass fiber penetrated by the first through wiring. As a result, the degree of freedom of the disposition of the second through wiring in the multilayer substrate can be increased in a state in which the concern that the short-circuit abnormality due to the growth of the migration occurs is reduced.

In the above-described aspect of the liquid ejecting apparatus, the first ejection control signal may be a signal of a ground potential.

In the above-described aspect of the liquid ejecting apparatus, the second ejection control signal may be an amplified power supply voltage signal used for generating a drive signal that drives the head unit.

According to the liquid ejecting apparatus, the concern that the short-circuit abnormality due to the growth of the migration occurs between the first through wiring and the second through wiring is reduced even when the potential difference between the first through wiring and the second through wiring is large because the signal of the ground potential is propagated through the first through wiring and the amplified power supply voltage signal having a large voltage value is propagated through the second through wiring.

In the above-described aspect of the liquid ejecting apparatus,

the head unit may have a piezoelectric element that includes a first electrode and a second electrode and is driven in response to a potential difference between the first electrode and the second electrode, and ejects the liquid onto the medium by the driving of the piezoelectric element,

the first ejection control signal may be a drive signal supplied to the first electrode, and

the second ejection control signal may be a reference voltage signal supplied to the second electrode.

According to the liquid ejecting apparatus, the concern that the short-circuit abnormality due to the growth of the migration occurs between the first through wiring and the second through wiring is reduced even when the drive signal is propagated through the first through wiring and the reference voltage signal is propagated through the second through wiring.

In the above-described aspect of the liquid ejecting apparatus, no wiring pattern that is not electrically connected to the first through wiring and the second through wiring may be provided between the first through wiring and the second through wiring.

In the above-described aspect of the liquid ejecting apparatus, no circuit element may be provided between the first through wiring and the second through wiring.

In the above-described aspect of the liquid ejecting apparatus,

the multilayer substrate may include

a third wiring layer that is positioned between the first insulating layer and the second wiring layer along the stacking direction, and

a second insulating layer that is positioned between the third wiring layer and the second wiring layer,

the second insulating layer may include a plurality of glass fibers including a second glass fiber, and

a direction in which the first glass fiber extends and a direction in which the second glass fiber extends may be substantially the same.

What is claimed is:

1. A liquid ejecting apparatus comprising:
a transport portion configured to transport a medium; and
a head unit configured to eject a liquid onto the medium in response to a plurality of ejection control signals, wherein
the head unit includes a multilayer substrate in which a plurality of wiring layers that propagate the plurality of ejection control signals are stacked,
the multilayer substrate includes
a first wiring layer and a second wiring layer among the plurality of wiring layers,
a first insulating layer that is positioned between the first wiring layer and the second wiring layer along a stacking direction in which the plurality of wiring layers are stacked, and
a first through wiring and a second through wiring, which penetrate the first insulating layer,
the first insulating layer contains a plurality of glass fibers including a first glass fiber,
the first through wiring penetrates the first glass fiber and propagates a first ejection control signal among the plurality of ejection control signals, and
the second through wiring does not penetrate the first glass fiber and propagates a second ejection control signal different from the first ejection control signal in voltage value among the plurality of ejection control signals.

2. A liquid ejecting apparatus comprising:
a transport portion configured to transport a medium; and
a head unit configured to eject a liquid onto the medium in response to a plurality of ejection control signals, wherein
the head unit includes a multilayer substrate in which a plurality of wiring layers that propagate the plurality of ejection control signals are stacked,
the multilayer substrate includes
a first wiring layer and a second wiring layer among the plurality of wiring layers,
a first insulating layer that is positioned between the first wiring layer and the second wiring layer along a stacking direction in which the plurality of wiring layers are stacked, and
a first through wiring and a second through wiring, which penetrate the first insulating layer,
the first insulating layer contains a plurality of glass fibers including a first glass fiber,
the first through wiring penetrates the first glass fiber and propagates a first ejection control signal among the plurality of ejection control signals, and
the second through wiring does not penetrate the first glass fiber in a region having a diameter smaller than 5 times a diameter of the first through wiring, centered on the first through wiring, and propagates a second ejection control signal different from the first ejection control signal in voltage value among the plurality of ejection control signals.

3. The liquid ejecting apparatus according to claim 1, wherein
the first ejection control signal is a signal of a ground potential.

4. The liquid ejecting apparatus according to claim 3, wherein
the second ejection control signal is an amplified power supply voltage signal used for generating a drive signal that drives the head unit.

5. The liquid ejecting apparatus according to claim 1, wherein
the head unit has a piezoelectric element that includes a first electrode and a second electrode and is driven in response to a potential difference between the first electrode and the second electrode, and ejects the liquid onto the medium by the driving of the piezoelectric element,
the first ejection control signal is a drive signal supplied to the first electrode, and
the second ejection control signal is a reference voltage signal supplied to the second electrode.

6. The liquid ejecting apparatus according to claim 1, wherein
no wiring pattern that is not electrically connected to the first through wiring and the second through wiring is provided between the first through wiring and the second through wiring.

7. The liquid ejecting apparatus according to claim 1, wherein
no circuit element is provided between the first through wiring and the second through wiring.

8. The liquid ejecting apparatus according to claim 1, wherein
the multilayer substrate includes
a third wiring layer that is positioned between the first insulating layer and the second wiring layer along the stacking direction, and
a second insulating layer that is positioned between the third wiring layer and the second wiring layer,
the second insulating layer includes a plurality of glass fibers including a second glass fiber, and
a direction in which the first glass fiber extends and a direction in which the second glass fiber extends are substantially the same.
